(19) United States
(12) Patent Application Publication
(10) Pub. No.: US 2024/0232979 A9
(43) Pub. Date: Jul. 11, 2024

(54) INFORMATION PROCESSING APPARATUS, INFORMATION PROCESSING METHOD, AND PROGRAM

(71) Applicant: Shiseido Company, Ltd., Chuo-ku, Tokyo (JP)

(72) Inventors: Naruhito TOYODA, Tokyo (JP); Noriko HASEGAWA, Tokyo (JP); Takeru OMINAMI, Tokyo (JP); Tomohiro SAKAGUCHI, Tokyo (JP); Seiko MORI, Tokyo (JP)

(73) Assignee: Shiseido Company, Ltd., Chuo-ku, Tokyo (JP)

(21) Appl. No.: 18/277,330

(22) PCT Filed: Nov. 8, 2021
(86) PCT No.: PCT/JP2021/040951

§ 371 Date: Aug. 15, 2023

(30) Foreign Application Priority Data
Feb. 16, 2021 (JP) 2021-022360

(51) Int. Cl. G06Q 30/0601; G06V 40/16

(52) U.S. Cl. CPC G06Q 30/0631; G06Q 30/0641; G06V 40/168

(57) ABSTRACT

An information processing apparatus includes a module configured to receive face information on a user's face and needs information on the user's needs regarding makeup, a module configured to specify a feature quantity of the user's face based on the face information, a module configured to determine recommendation makeup information on the makeup recommended for the user based on the specified feature quantity and the needs information, a module configured to present the determined recommendation makeup information to the user, and a module configured to receive evaluation information on evaluation of the recommendation makeup information from the user who has applied the makeup after the recommendation makeup information is presented.

### TECHNICAL FIELD

The present invention relates to an information processing apparatus, an information processing method, and a program.

### BACKGROUND

A system is known that proposes a makeup simulation image that suits a user based on a user's face image and interview information such as favorite impression (for example, Japanese Patent Application Laid-Open No. 2001-346627).

Also, a system is known that stores the evaluation (degree of satisfaction, or the like) of the makeup simulation image presented to the user is detected from the user's facial expression or line of sight, and the detected evaluation information, user identification information, and the makeup simulation information associated with each other, generates a makeup simulation image in consideration of the evaluation information (for example, international publication WO 2017/115453).

### SUMMARY OF INVENTION

### Technical Problem

In recent years, application-based makeup recommendation technologies often employ a mechanism that analyzes individual needs or facial features such as the user's preferences or individual such as facial features and recommends makeup.

However, since the facial features do not change significantly from day to day, the proposed makeup patterns become uniform no matter how many times the application is used, and the user does not feel attractive.

Moreover, in the case of proposals based on the user's preferences, even if the user likes the makeup, the desired finish may not be obtained due to the user's lack of skill in technique.

These problems can cause users to stop using the application.

One of the objects of the present invention is to propose makeup that will give the user satisfaction when the user applies makeup.

### Solution to Problem

One aspect of the present invention is an information processing apparatus comprising:
a module configured to receive face information on a user's face and needs information on the user's needs regarding makeup;
a module configured to specify a feature quantity of the user's face based on the face information;
a module configured to determine recommendation makeup information on the makeup recommended for the user based on the specified feature quantity and the needs information;
a module configured to present the determined recommendation makeup information to the user; and
a module configured to receive evaluation information on evaluation of the recommendation makeup information from the user who has applied the makeup after the recommendation makeup information is presented.

### BRIEF DESCRIPTION OF DRAWINGS

FIG. 1 is a block diagram showing the configuration of the information processing system of the present embodiment.

FIG. 2 is an explanatory diagram of an overview of the present embodiment.

FIG. 3 is a diagram showing the data structure of a user information database of the present embodiment.

FIG. 4 is a diagram showing the data structure of a recommendation log information database of the present embodiment.

FIG. 5 is a flowchart of process of recommendation makeup information presentation of the present embodiment.

FIG. 6 is a diagram showing an example of a screen displayed in process of recommendation makeup information presentation of the present embodiment.

FIG. 7 is a diagram showing an example of a screen displayed in process of recommendation makeup information presentation of the present embodiment.

FIG. 8 is a diagram showing an example of a screen displayed in process of recommendation makeup information presentation of the present embodiment.

FIG. 9 is a flowchart of process of user feedback of the present embodiment.

FIG. 10 is a diagram showing an example of a screen displayed in process of user feedback of the present embodiment.

FIG. 11 is a diagram showing the data structure of a recommendation log information database of the variation 1.

FIG. 12 is a flowchart of process of recommendation makeup information presentation of the variation 1.

FIG. 13 is a diagram showing an example of a screen displayed in the process of recommendation makeup information presentation of the variation 1.

FIG. 14 is a diagram showing an example of a screen displayed in process of recommendation makeup information presentation of the variation 1.

FIG. 15 is a flowchart of process of recommendation makeup information presentation of the variation 2.

FIG. 16 is a diagram showing an example of a screen displayed in the process of recommendation makeup information presentation of the variation 2.

FIG. 17 is a flowchart of process of user feedback of the variation 2.

FIG. 18 is a diagram showing an example of a screen displayed in the process of user feedback of the variation 2.

FIG. 19 is a flowchart of process of user feedback of the variation 3.

FIG. 20 is a flowchart of process of user feedback of the variation 4.

FIG. 21 is a diagram showing a variation of screen P12 of the present embodiment.

FIG. 22 is a diagram showing a variation of screen P12 of the present embodiment.

### DESCRIPTION OF EMBODIMENTS

Hereinafter, an embodiment of the present invention is described in detail based on the drawings.

Note that, in the drawings for describing the embodiments, the same components are denoted by the same reference sign in principle, and the repetitive description thereof is omitted.

### (1) Configuration of Information Processing System

The configuration of the information processing system will be described.

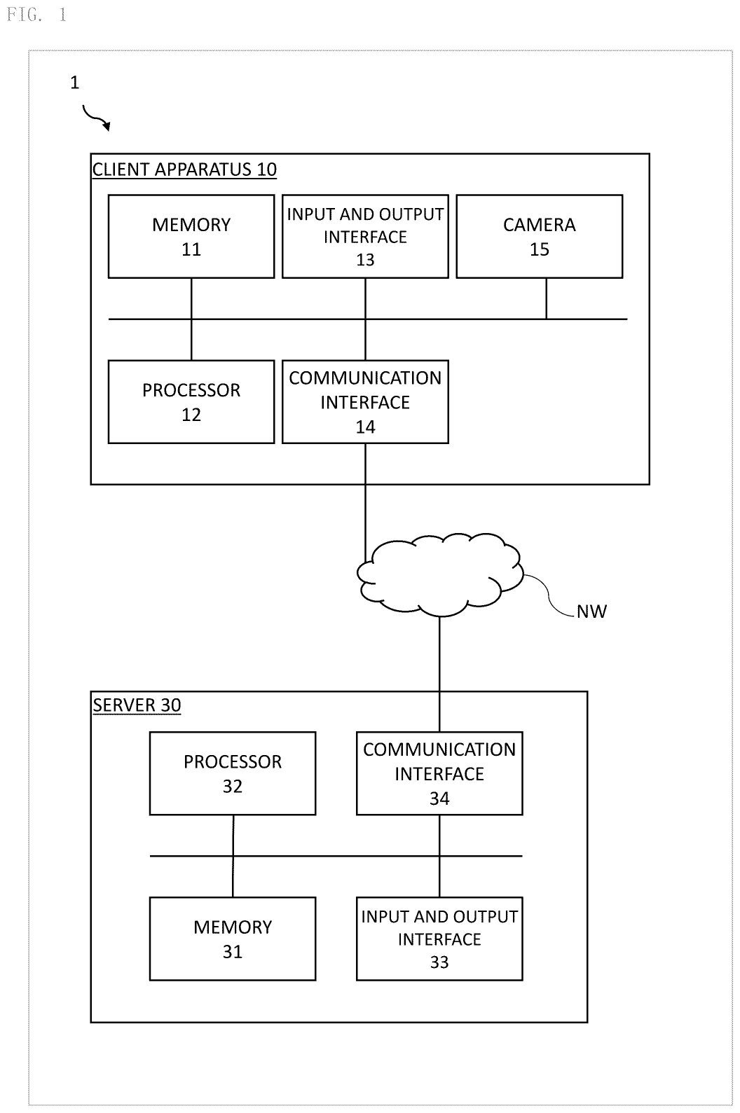

FIG. 1 is a block diagram showing the configuration of the information processing system of the present embodiment.

As shown in FIG. 1, the information processing system 1 includes a client apparatus 10 and a server 30.

The client apparatus 10 and the server 30 are connected via a network (for example, an internet or an intranet) NW.

The client apparatus 10 is a computer (an example of an “information processing apparatus”) that transmits a request to the server 30.

The client apparatus 10 is, for example, a smart phone, a tablet terminal, or a personal computer.

The server 30 is a computer (an example of an “information processing apparatus”) that provides the client apparatus 10 with a response in response to the request transmitted from the client apparatus 10.

The server 30 is, for example, a web server.

### (1-1) Configuration of Client Apparatus

A configuration of the client apparatus 10 will be described.

As shown in FIG. 1, the client apparatus 10 includes a memory 11, a processor 12, an input and output interface 13, and a communication interface 14, and a camera 15.

The memory 11 is configured to store programs and data.

The memory 11 is, for example, a combination of a ROM (read only memory), a RAM (random access memory), and a storage (for example, a flash memory or a hard disk).

The programs include, for example, the following programs:
OS (Operating System) program; and
Programs of applications that execute information processing (for example, web browsers).

The data includes, for example, the following data:
Databases referenced in information processing; and
Data obtained by executing the information processing.

The processor 12 is configured to implement the functions of the client apparatus 10 by activating programs stored in the memory 11.

The processor 12 is, for example, a CPU (Central Processing Unit), an ASIC (Application Specific Integrated Circuit), an FPGA (Field Programmable Gate Array), or a combination thereof.

The input and output interface 13 is configured to acquire a user instruction from an input device connected to the client apparatus 10 and output information to an output device connected to the client apparatus 10.

The input device is, for example, a keyboard, a pointing device, a touch panel, or a combination thereof.

The output device is, for example, a display.

The communication interface 14 is configured to control communications between the client apparatus 10 and the server 30.

The camera 15 is configured to capture images (for example, still image or moving image).

### (1-2) Configuration of Server

A configuration of the server 30 will be described.

As shown in FIG. 1, the server 30 includes a memory 31, a processor 32, an input and output interface 33, and a communication interface.

The memory 31 is configured to store programs and data.

The memory 31 is, for example, a combination of a ROM, a RAM, and a storage (for example, flash memory or hard disk).

The programs include, for example, the following programs:
OS program; and
Programs of applications that execute information processing.

The data includes, for example, the following data:
Databases referenced in the information processing; and
Execution result of the information processing.

The processor 32 is configured to implement the functions of the server 30 by activating programs stored in the memory 31.

The processor 32 is, for example, a CPU, an ASIC, a FPGA, or a combination thereof.

The input and output interface 33 is configured to acquire user instruction from an input device connected to the server 30 and to output information to an output device connected to the server 30.

The input device is, for example, a keyboard, a pointing device, a touch panel, or a combination thereof.

The output device is, for example, a display.

The communication interface 34 is configured to control communications between the server 30 and the client apparatus 10.

### (2) Summary of Embodiment

A summary of the present embodiment will be described.

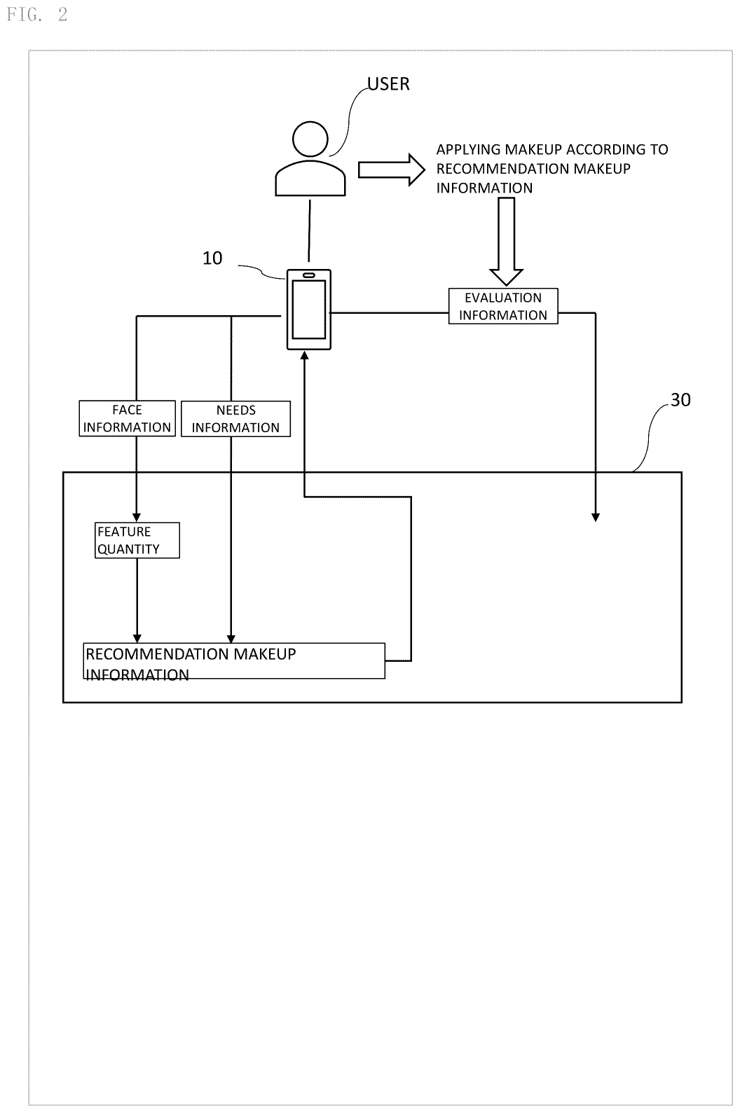

FIG. 2 is an explanatory diagram of the summary of the present embodiment.

As shown in FIG. 2, the server 30 receives, via the client apparatus 10, face information on the user's face and needs information on the user's needs for makeup.

The server 30 specifies the feature quantity of the user's face based on the face information.

The server 30 determines recommendation makeup information on makeup recommended to the user based on the specified feature quantity and the needs information.

The server 30 presents the determined recommendation makeup information to the user via the client apparatus 10.

The server 30 receives, via the client apparatus 10, evaluation information on evaluation of the recommendation makeup information from the user who applied makeup according to the recommendation makeup information.

### (3) Database

A database of the present embodiment will be described.

The following databases are stored in the memory 31.

### (3-1) User Information Database

The user information database of the present embodiment will be described.

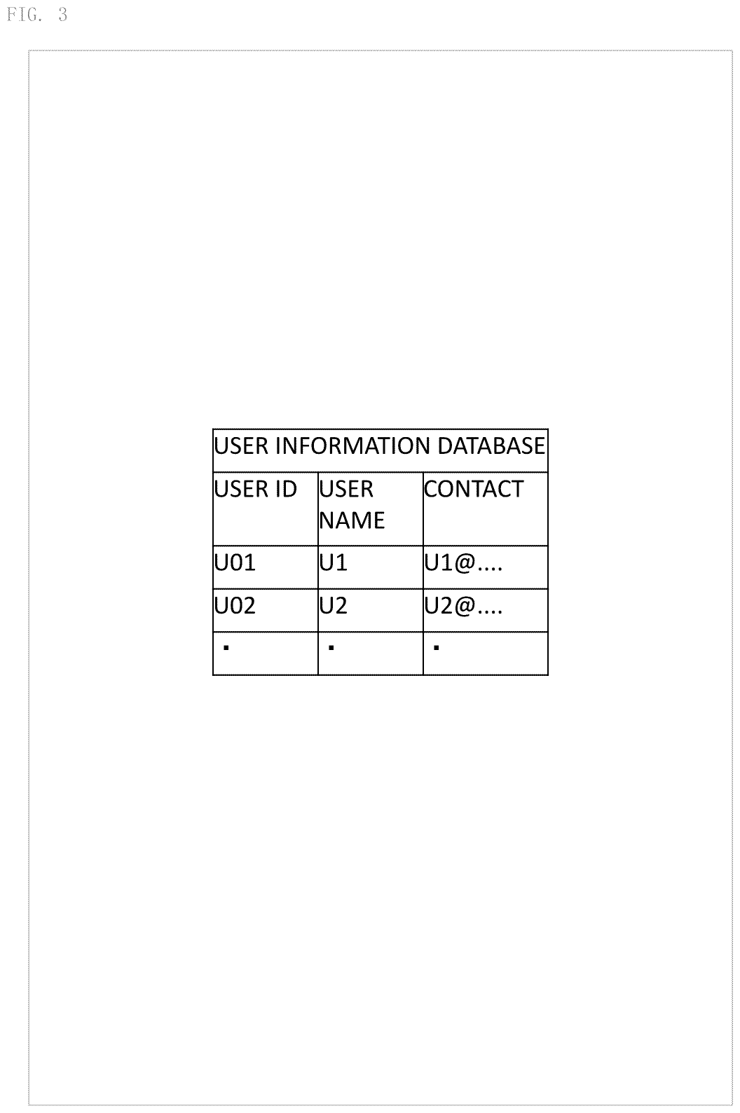

FIG. 3 is a diagram showing the data structure of the user information database of the present embodiment.

The user information database of FIG. 3 stores user information on users.

The user information database includes a “user ID” field, a “user name” field, and a “contact” field.

Each field is associated with each other.

The “user ID” field stores a user ID.

A user ID is an example of user identification information that identifies a user.

The “user name” field stores user name information.

The user name information is information (for example, text) on a user name.

The user name information is an example of user identification information.

The “contact” field stores contact information of the user.

The contact information includes, for example, at least one of the following:
Mail address;
Mobile phone number;
Accounts for web services (for example, social network services); and
Accounts for communication tools.

The user information database may store address information of the user, password information, or the like.

### (3-2) Recommendation Log Information Database

The recommendation log information database of the present embodiment will be described.

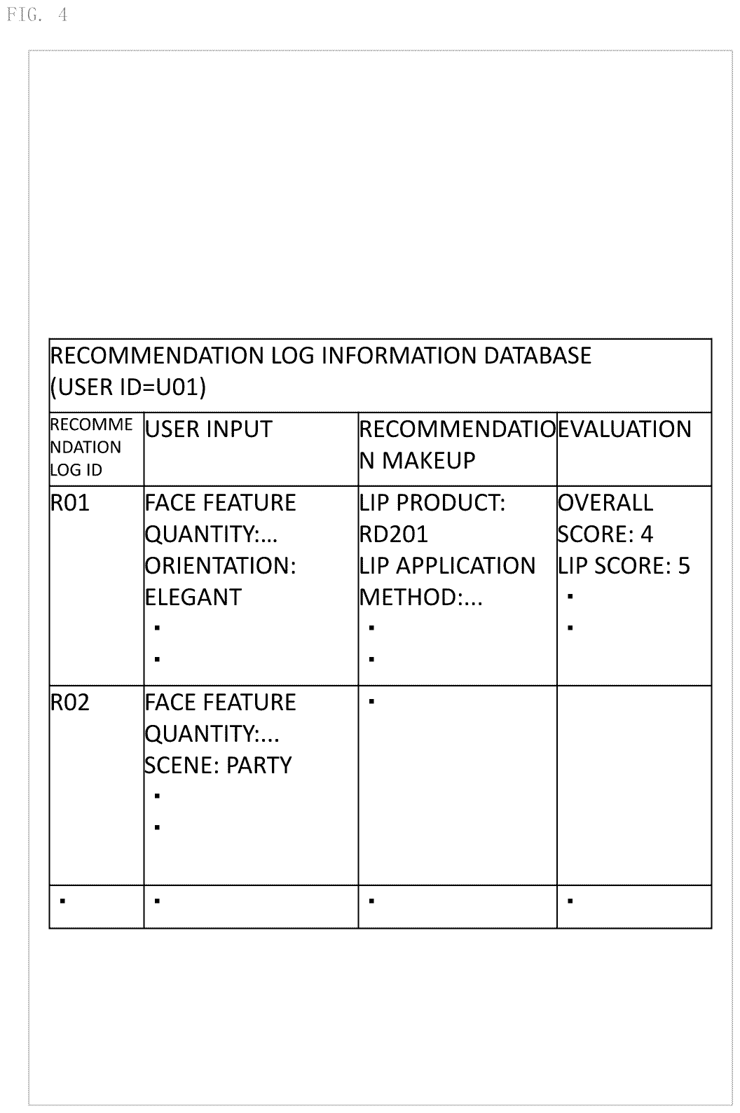

FIG. 4 is a diagram showing the data structure of the recommendation log information database of the present embodiment.

The recommendation log information database shown in FIG. 4 stores recommendation makeup information presented to the user and recommendation log information on the history of information provided by the user.

The recommendation log information database includes a “recommendation log ID” field, and a “user input” field, a “recommendation makeup” field, and an “evaluation” field.

Each field is associated with each other.

The recommendation log information database is associated with the user ID.

The “recommendation log ID” field stores a recommendation log ID.

The recommendation log ID is information for identifying recommendation log information.

The “user input” field stores user input information.

The user input information includes, for example, the following information:
Information on feature quantity of the face specified based on the user's face image (hereinafter referred to as “face feature quantity information”);
Needs information; and
Image data of the user's face image.

The “recommendation makeup” field stores recommendation makeup information presented to the user.

The “evaluation” field stores evaluation information on the user's evaluation of the recommendation makeup information.

### (4) Information Process

Information process of the present embodiment will be described.

In the present embodiment, first, the information processing system 1 performs process of recommendation makeup information presentation.

Then, the user applies makeup according to the presented recommendation makeup information.

After that, the information processing system 1 performs process of user feedback.

### (4-1) Process of Recommendation Makeup Information Presentation

The process of recommendation makeup information presentation of the present embodiment will be described.

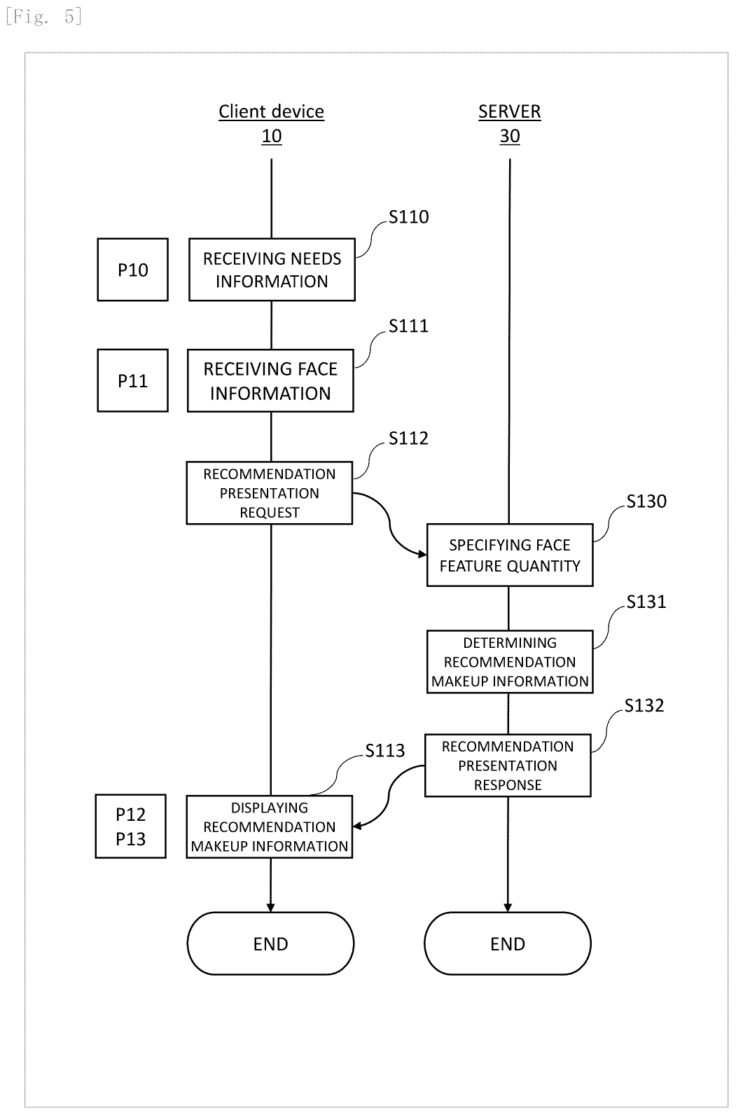

FIG. 5 is a flowchart of process of recommendation makeup information presentation of the present embodiment.

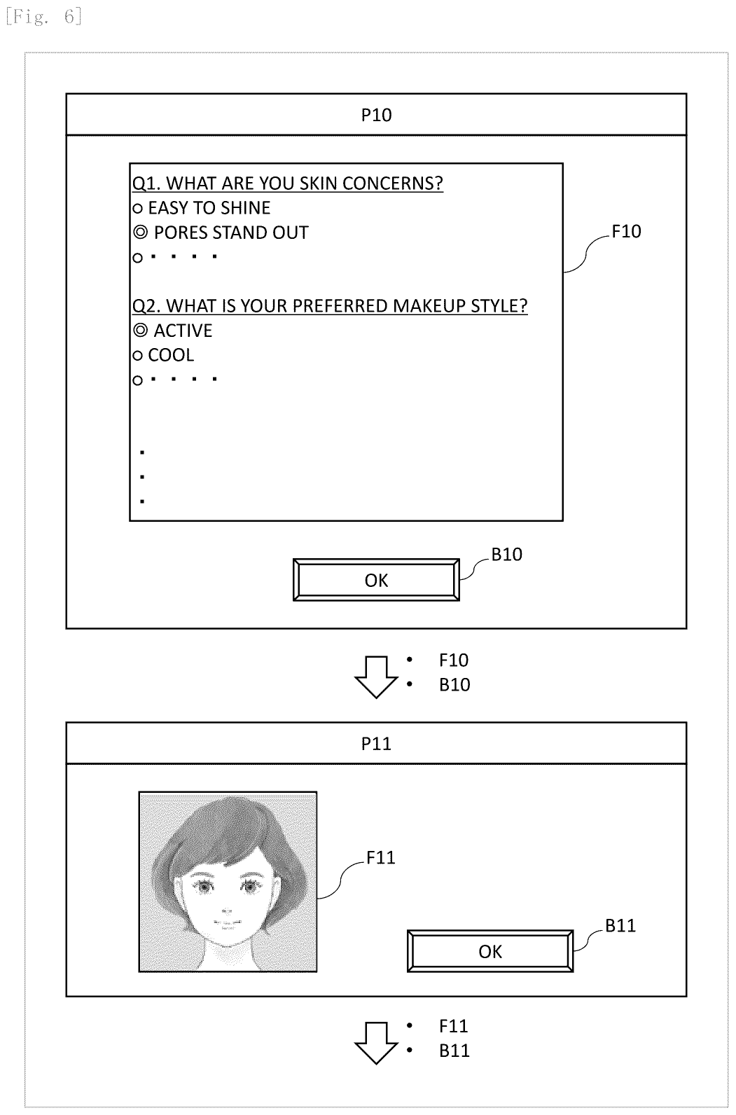

FIG. 6 is a diagram showing an example of a screen displayed in the process of recommendation makeup information presentation of the present embodiment.

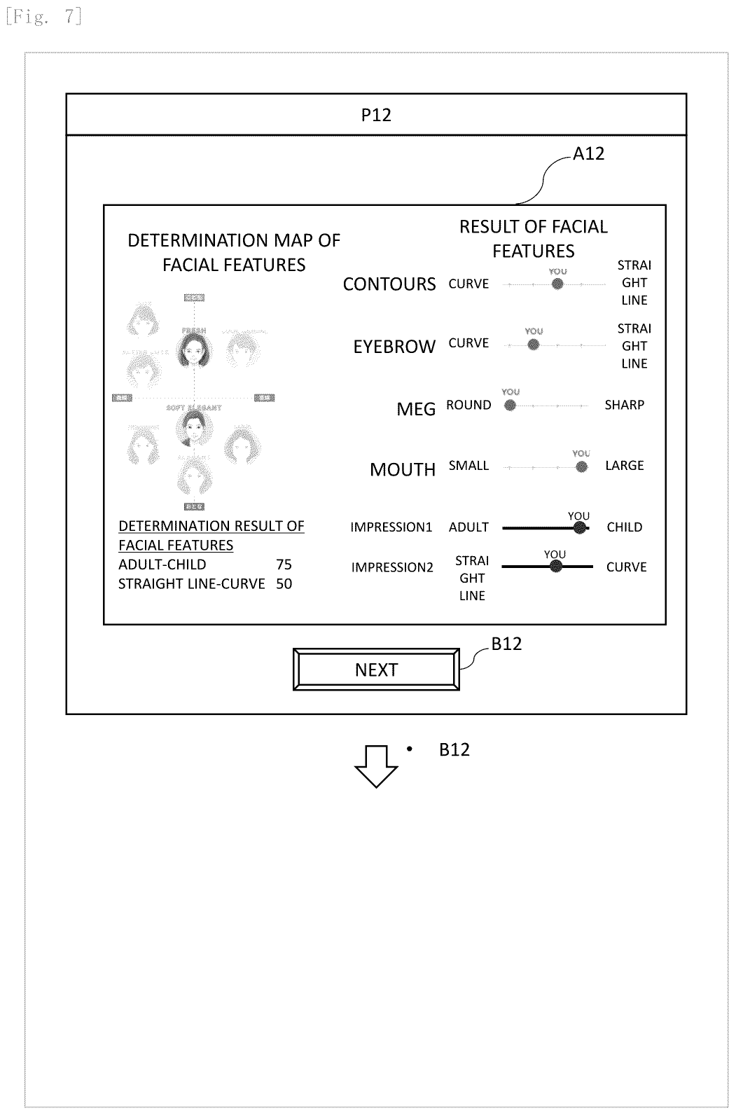

FIG. 7 is a diagram showing an example of a screen displayed in the process of recommendation makeup information presentation of the present embodiment.

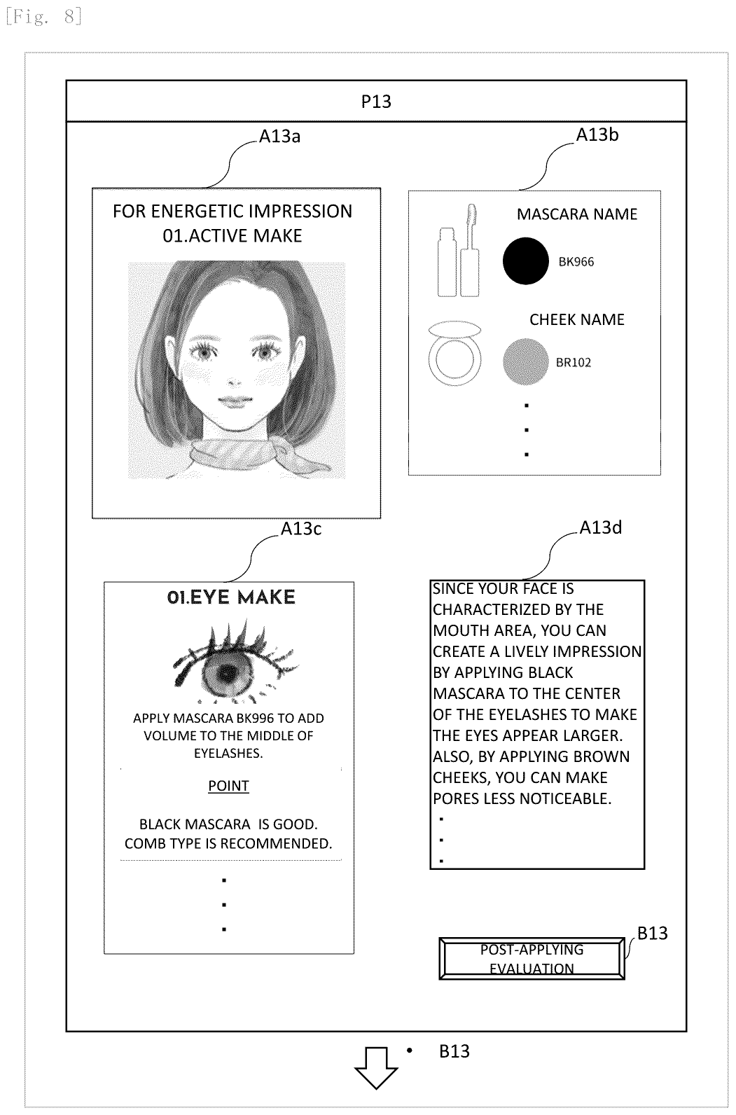

FIG. 8 is a diagram showing an example of a screen displayed in the process of recommendation makeup information presentation of the present embodiment.

In the process of recommendation makeup information presentation of FIG. 5, for example, is triggered by a predetermined user instruction (for example, the user instruction to designate an application for executing the process of recommendation makeup information presentation or the user instruction to log in to a web service) provided to the client apparatus 10.

As shown in FIG. 5, the client apparatus 10 executes receiving needs information (S110).

Specifically, the processor 12 displays screen P10 (FIG. 6) on the display.

The screen P10 includes a field object F10 and an operation object B10.

The field object F10 is an object that receives a user instruction for designating needs information on the user's needs for makeup.

The operation object B10 is an object that receives a user instruction for transitioning to the screen P11 (FIG. 6).

The needs information includes, for example, needs item information on the needs item and needs content information on the needs content for the needs item.

The needs item is, for example, regarding at least one of the following:
Makeup preferences (in this case, the needs content is, for example, a preference for makeup that makes the eyes look bigger);
User attributes (for example, gender, age, occupation, area of residence, nationality, or the like);
Concerns regarding facial features (in this case, the needs content is, for example, to look childish, to be concerned regarding narrow eyes, or the like);
Concerns regarding skin (in this case, the needs content is, for example, concerns about dry skin, concerns about blemishes, or the like);
Direction (taste) of this makeup (in this case, the needs content is, for example, elegant, cute, sophisticated, mannish, boyish, fresh, warm, mature, or the like);
Usage scene of this makeup (in this case, needs content is, for example, party, business, or the like);
Makeup skill level;
Makeup tools owned by users (cosmetics, applicators, or the like); and
Preferences other than makeup (for example, preferences for fashion style (bags, shoes, or the like), hairstyles, nails, or the like).

For example, the needs content may be selected from presented options, or may be input as text.

In one example, the needs item information may be stored in the memory 31.

For example, according to a user instruction, the processor 12 transmits needs item information presentation request data to the server 30, and the server 30 transmits needs item information presentation response data including the needs item information to the client apparatus 10.

The needs item information included in the needs item information presentation response data is displayed in the field object F10.

In another example, the needs item information is specified by the user in the field object F10.

For example, the user inputs a needs item into the field object F10 as text.

When the user designates needs information in the field object F10 and operates the operation object B10, the processor 12 stores the needs information in the memory 11.

After step S110, the client apparatus 10 executes receiving face information (S111).

Specifically, the processor 12 displays a screen P11 (FIG. 6) on the display.

The screen P11 includes a field object F11 and an operation object B11.

The field object F11 is an object that receives a user instruction for designating a user's face image (an example of “face information on the user's face”).

The operation object B11 is an object that receives a user instruction for transmitting the user instruction input to the field objects F10 and F11 to the server 30.

When the user designates the image data of his or her face image (for example, the image of the real face) in the field object F11 and operates the operation object B11, the processor 12 stores the image data of the face image in the memory 11.

The face image may be a still image or a moving image.

Also, the number of face images may be one or plural.

A face image is, for example, a face image captured by the camera 15.

After step S111, the client apparatus 10 executes a recommendation presentation request (S112).

Specifically, the processor 12 transmits recommendation presentation request data to the server 30.

The recommendation presentation request data includes, for example, the following information:
User ID;
Needs information stored in the memory 11 in step S110; and
Image data of the face image stored in the memory 11 in step S111.

After step S112, the server 30 executes specifying face feature quantity (S130).

Specifically, the processor 32 analyzes the image data included in the recommendation presentation request data to specify the feature quantity (hereinafter referred to as “face feature quantity”) of the user's face.

The face feature quantity represents at least one of a feature regarding the form of each part of the face and a feature regarding the balance of forms between the parts.

The part includes, for example, at least one of the following:
Contour;
Eyebrow;
Eyelashes;
Eye;
Nose;
Lips;
Cheek;
Forehead; and
Chin.

The form for each part includes, for example, at least one of the following:
Size;
Shape;
Placement;
Color;
Angle;
Light and shade;
Unevenness; and
Hair mass.

The processor 32 adds a new record to the recommendation log information database (FIG. 4).

Each field in the new record contains the following information:
New recommendation log ID is stored in the “recommendation log ID” field;
Needs information and image data of the face image included in the recommendation presentation request data, and the specified face feature quantity information is stored in the “user input” field.

After step S130, the server 30 executes determining recommendation makeup information (S131).

In the first example of step S131, the memory 31 stores recommendation models.

In the recommendation model, algorithms (for example, makeup logic selection algorithms) to select makeup information to be recommended to the user based on the relationship between the face feature quantity, the needs information, and the makeup information (that is, the combination of the face feature quantity and the needs information (for example, user vector)) are described.

The makeup information (hereinafter referred to as “product information”) includes at least one of information on makeup products, information (hereinafter referred to as “method information”) on makeup methods, and information (hereinafter “reasons information”) on the reasons why the makeup products and makeup methods are recommended and information (hereinafter referred to as “type information”) about the type of makeup.

The recommendation model is, for example, a trained model (using machine learning as an example) or a statistical model.

The recommendation model includes, for example, multiple coefficients.

The coefficient is a value used for calculation to specify the makeup information to be recommended to the user from the needs information and face feature quantity information.

The coefficient is, for example, a weighting coefficient for eye width.

The product information includes, for example, at least one of the following:
Information on a name of markup products (for example, text);
Information on model numbers of makeup products;
Information on the beauty of makeup products (for example, foundation, foundation, cheek, powder, lipstick, gloss, liner, or the like);
Information on colors of makeup products (for example, color names, color values, or the like);
Information on texture of makeup products;
Information on formulations of makeup products; and
Image data of makeup products.

The method information includes, for example, at least one of the following:
Information on the application position of makeup products;
Information on the application shape of makeup products;
Information on the application amount of makeup products;
Information on applicators for applying makeup products (for example, applicator name, model number, method of holding, or the like); and
Information on how to apply makeup products.

Reason information includes for example, at least one of the following:
Information on reasons related to face feature quantity (for example, information on a type of facial features classified from face feature quantity, information on facial features specified from face feature quantity, impressions of facial features specified from face feature quantity), information on a personal color (for example, determination of blue-based and yellow-based) specified from the face feature quantity.

These pieces of information may be specified by the server 30.
Information on reasons related to needs information (for example, concerns regarding skin, concerns regarding facial features, usage scenes, or the like).

The type information includes, for example, at least one of the following:
Information (for example, text) on a name of makeup type;
Image illustration of makeup finish; and
Image data of makeup finish.

The processor 32 inputs the face feature quantity specified in step S130 and the needs information included in the recommendation presentation request data into the recommendation model to output the makeup information corresponding to the needs information and the face feature quantity as the recommendation makeup information (that is, determine recommendation makeup information).

The recommendation makeup information is information on makeup recommended for the user.

The recommendation makeup information includes, for example, information on makeup products recommended to the user (hereinafter referred to as “recommendation product information”), information on makeup methods recommended to the user (hereinafter referred to as “recommendation method information”), and information on the reason why at least one of the makeup products and the makeup method is recommended to the user (hereinafter referred to as “recommendation reason information”), and information on the type of makeup recommended to the user (hereinafter referred to as “recommendation type information”).

In the second example of step S131, the memory 31 stores recommendation model.

The recommendation model describes an algorithm for selecting the makeup information to be recommended to the user, based on face feature quantity, needs information, recommendation log information (for example, history of evaluation information), and relationships between makeup information.

The processor 32 inputs the face feature quantity specified in step S130 and the needs information included in the recommendation presentation request data, and the recommendation log information (for example, the history of evaluation information) stored in the recommendation log information database (FIG. 4) associated with the user ID designated by the user to the recommendation model, and outputs the makeup information corresponding to the needs information, the face feature quantity, and the recommendation log information as the recommendation makeup information.

In both the first example and the second example of step S131, the processor 32 stores the determined recommendation makeup information (for example, the recommendation product information, the recommendation method, the recommendation reason information, and the recommendation type information) in the “recommendation makeup” field of the recommendation log information database (FIG. 4).

After step S131, the server 30 executes a recommendation presentation response (S132).

Specifically, the processor 32 transmits recommendation presentation response data to the client apparatus 10.

The recommendation presentation response data includes the following information:
Recommendation log ID stored in the “recommendation log ID” field in step S131;
Recommendation makeup information (for example, the recommendation product information, the recommendation method information, the recommendation reason information, and the recommendation type information) determined in step S131;

After step S132, the client apparatus 10 executes displaying recommendation makeup information (S113).

Specifically, the processor 12 displays the screen P12 (FIG. 7) on the display.

The screen P12 includes a display object A12 and an operation object B12.

The display object A12 includes information (an example of “recommendation reason information”) regarding the facial features of the user.

The operation object B12 is an object that receives a user instruction for transitioning to the screen P13 (FIG. 8).

When the user operates the operation object B12, the processor 12 displays the screen P13 (FIG. 8) on the display.

The screen P13 includes display objects A13a to A13d and an operation object B13.

The display object A13a includes recommendation type information included in the recommendation presentation response data.

The display object A13b includes recommendation product information included in the recommendation presentation response data.

The display object A13c includes the recommendation method information included in the recommendation presentation response data.

The display object A13d includes the recommendation reason information included in the recommendation presentation response data.

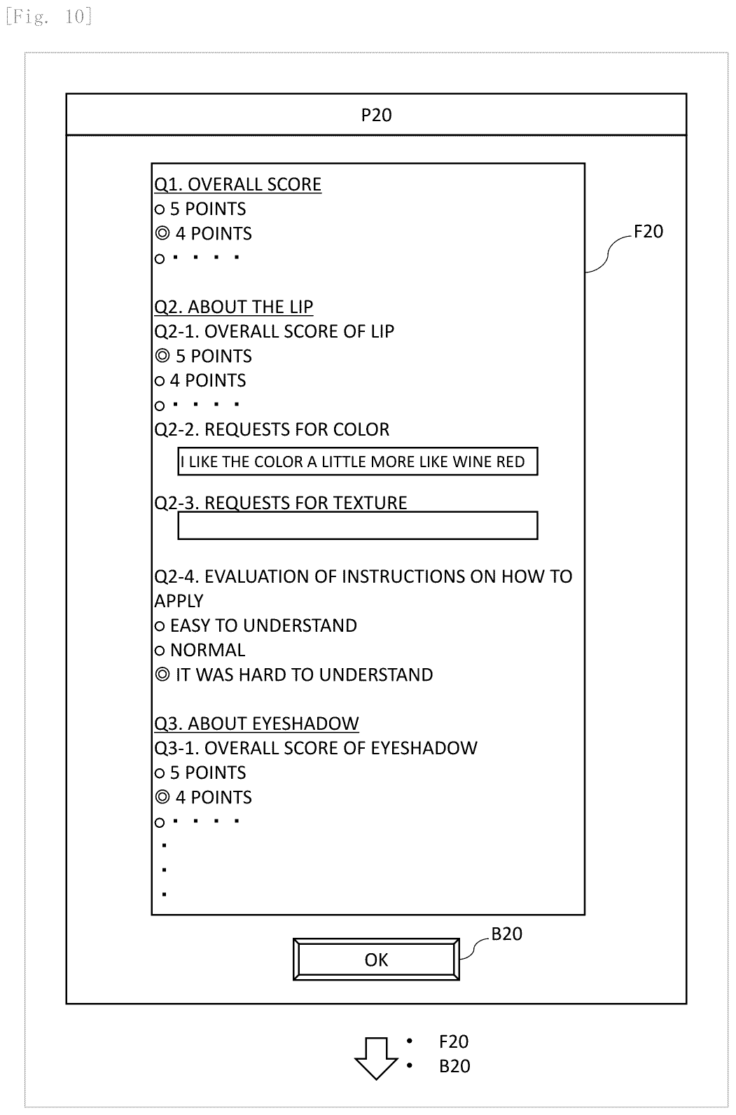

The operation object B13 is an object that receives a user instruction for transitioning to the screen P20 (FIG. 10).

After step S113, the user applies makeup according to the presented recommendation makeup information.

Currently, for example, the user applies makeup while looking at the screen P13 (FIG. 8).

### (4-2) Process of User Feedback

The process of user feedback of the present embodiment will be described.

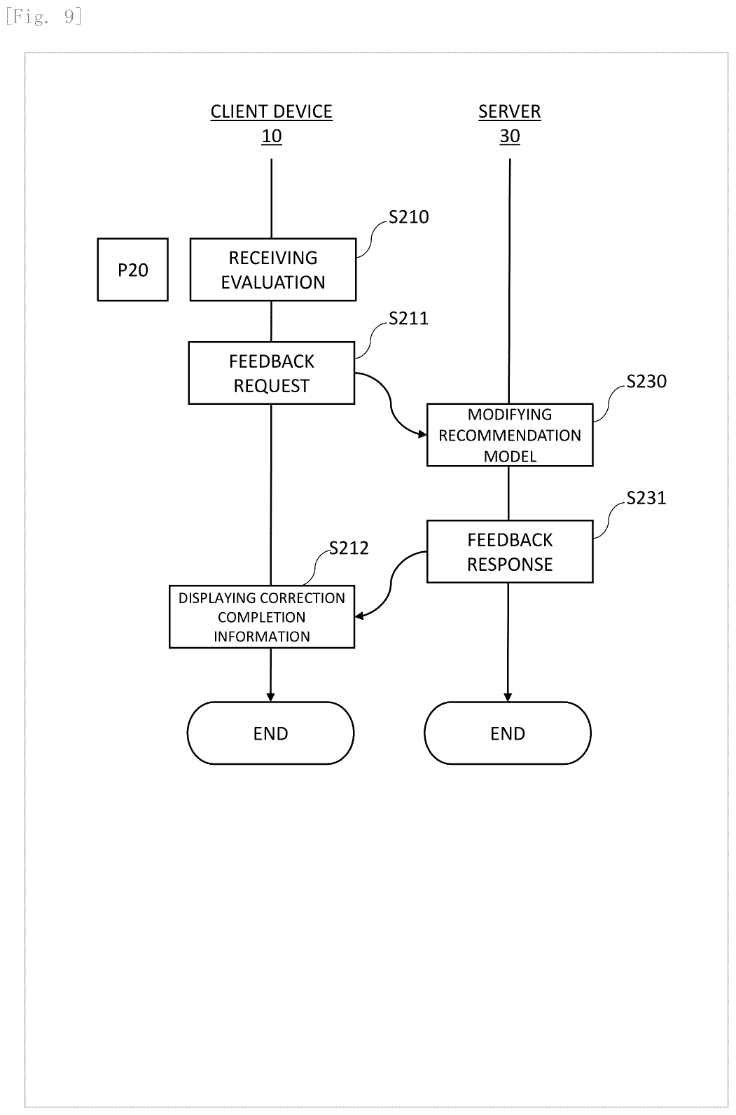

FIG. 9 is a flowchart of process of user feedback of the present embodiment.

FIG. 10 is a diagram showing an example of a screen displayed in process of user feedback of the present embodiment.

The process of user feedback in FIG. 9 is processing that is executed after the user applies makeup according to the presented recommendation makeup information.

As shown in FIG. 9, the client apparatus 10 executes receiving evaluation (S210).

Specifically, when the user who has applied makeup according to the recommendation makeup information operates the operation object B13 on the screen P13 (FIG. 8), the processor 12 displays the screen P20 (FIG. 10) on the display.

The screen P20 includes a field object F20 and an operation object B20.

The field object F20 is an object that receives user instructions for designating evaluation information on evaluation of the recommendation makeup information.

The operation object B20 is an object that receives a user instruction for transmitting the user instruction input to the field object F20 to the server 30.

The evaluation information includes, for example, evaluation item information on an evaluation item and evaluation result information on an evaluation result for the evaluation item.

The evaluation items relate to, for example, at least one of the following presented information:
Overall recommendation makeup information;
Recommendation product information;
Recommendation method information;
Recommendation reason information; and
Recommendation type information.

Evaluation items relate to, for example, at least one of the following facial regions:
Whole face;
Skin;
Eyebrow;
Eyelashes;
Eye;
Nose;
Lips; and
Cheek.

The evaluation item relates to at least one of the following contents, for example:
Preferences (the evaluation result includes, for example, “satisfactory” to “unsatisfactory”, “like” to “dislike”, “suitable” to “not suitable”, or the like);
Color tone (for example, color, shading, brightness, gloss, or the like) of makeup products (the evaluation result includes, for example, “redder is good”);
Given impression (the evaluation result includes, for example, “looking old”, “too cute”, or the like); and
Techniques (the evaluation result includes, for example, “easy” to “difficult”, “explanation is easy to understand” to “explanation is difficult to understand”, or the like).

The evaluation result may be expressed numerically or by characters, for example.

Also, the evaluation result may be selected from presented options, or may be input as text, for example.

Specific examples of the evaluation items are, for example, “color of lipstick”, “description of how to apply eye shadow”, “impression of entire face”, or the like.

Specific examples of the evaluation results are, for example, “I like pink a little more”, “The explanation is difficult to understand”, “Too plain”, or the like.

In one example, the evaluation item information is included in the recommendation presentation response data.

The field object F20 displays the evaluation item information included in the recommendation presentation response data.

In another example, when the user operates the operation object B13 on the screen P13 (FIG. 8), the processor 12 transmits the evaluation item information presentation request data to the server 30, and the server 30 transmits the evaluation item information presentation response data including the evaluation item information to the client apparatus 10.

The field object F20 displays the evaluation item information included in the evaluation item information presentation response data.

In yet another example, the user designates the evaluation item information in the field object F20.

For example, the user inputs the evaluation item into the field object F20 as text.

When the user designates the evaluation information into the field object F20 and operates the operation object B20, the processor 12 stores the evaluation information in the memory 11.

Note that the user applies makeup according to the recommendation makeup information, and designates the evaluation information based on the results of the applied makeup.

After step S210, the client apparatus 10 executes a feedback request (S211).

Specifically, processor 12 transmits feedback request data to server 30.

Feedback request data includes, for example, the following information:
User ID;
Recommendation log ID included in recommendation presentation response data; and
Evaluation information stored in the memory 11 in step S210.

After step S211, the server 30 executes modifying the recommendation model (S230).

Specifically, in the recommendation log information database (FIG. 4) associated with the user ID included in the feedback request data, the processor 32 stores the evaluation information included in feedback request data in the “evaluation” field associated with the recommendation log ID included in the feedback request data.

A memory 31 stores a modification model.

The modification model describes the correlation between the evaluation item information and the modification parameters of the coefficients of the recommendation model.

The processor 32 inputs the evaluation result information for each evaluation item included in the feedback request data into the modification model and determines modification parameters of the coefficients of the recommendation model.

The processor 32 modifies each coefficient of the recommendation model using the modification parameters.

For example, in the modification model, each piece of evaluation item information corresponds to at least one of the coefficients.

The processor 32 modifies at least one of the coefficients using modification parameters according to the evaluation result information corresponding to the evaluation item information.

As a result, the recommendation model reflects the evaluation information given by the user (for example, makeup information which the user wants or makeup information which the user does not want).

In this manner, the recommendation model is iteratively learned to present recommendation makeup information that reflects the evaluation information given by the user.

That is, the recommendation model is iteratively learned to improve the evaluation score.

After step S230, the server 30 executes a feedback response (S231).

Specifically, the processor 32 transmits feedback response data to the client apparatus 10.

The feedback response data includes, for example, correction completion information indicating that the recommendation model has been modified based on the evaluation information given by the user.

After step S231, the client apparatus 10 executes displaying correction completion information (S212).

Specifically, the processor 12 displays the correction completion information included in the feedback response data on the display.

According to the present embodiment, the server 30 receives evaluation information (for example, evaluation item information and evaluation result information) regarding evaluation of recommendation makeup information from a user who has applied makeup according to the recommendation makeup information.

Therefore, the server 30 can use the evaluation information to determine recommendation makeup information from the next time onward.

That is, the recommendation makeup for the next time onward is determined in consideration of the evaluation information based on the results of the makeup applied by the user according to the recommendation makeup information.

Therefore, it is possible to propose makeup that will give the user a sufficient satisfaction when applying makeup.

Conventionally, in the case that a makeup artist proposes makeup to a customer face-to-face, the makeup artist asks the customer about points of satisfaction and dissatisfaction in the conversation. The makeup artist adjusts the color tone or application method depending on the result to make customers satisfied with their makeup.

In addition, the makeup artist confirms the customer's technique level and presents how to apply and tips so that can be reproduced by the customer himself, thereby encouraging the customer to master the proposed makeup.

Considering such a makeup artist's response, it will be useful for an application to have a feedback function that asks for an evaluation of the makeup after the user has applied the recommended makeup.

By analyzing the evaluation obtained in this way and understanding detailed correction points, it is possible to propose makeup to make the user more satisfied.

In addition, since the technique level can also be grasped, it is possible to give careful advice on makeup methods, which makes it easier for the user to learn the technique, leading to further satisfaction of the user.

### (5) Variations

Variations of the present embodiment will be described.

### (5-1) Variation 1

Variation 1 will be described.

The variation 1 is an example in which a user can obtain the recommended makeup product, and the evaluation information is received from the user who has obtained the makeup product.

In the following description, a case where the user purchases (an example of “acquisition”) a recommended makeup product will be described as an example.

### (5-1-1) Recommendation Log Information Database

The recommendation log information database of the variation 1 will be described.

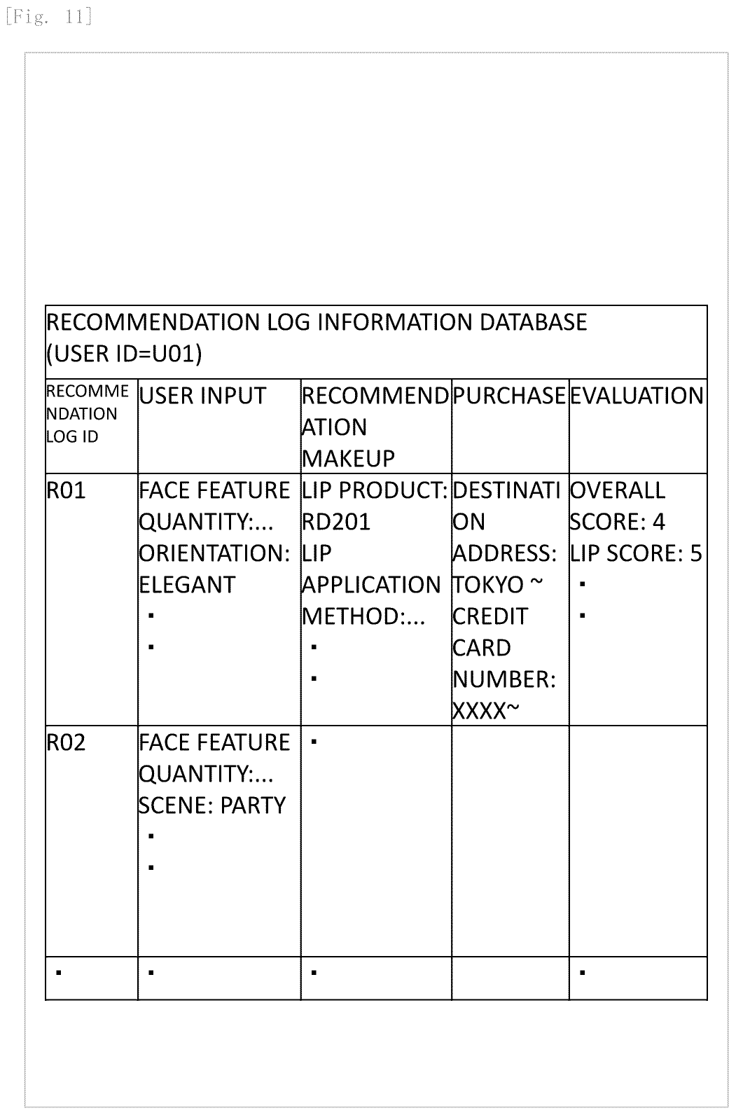

FIG. 11 is a diagram showing the data structure of the recommendation log information database of the variation 1.

The recommendation log information database of FIG. 11 stores recommendation log information on the history of recommendation makeup information presented to the user.

The recommendation log information database includes a “recommendation log ID” field, a “user input” field, a “recommendation makeup” field, a “purchase” field, and an “evaluation” field.

Each field is associated with each other.

The recommendation log information database is associated with the user ID.

The “recommendation log ID” field, “user input” field, “recommendation makeup” field, and “evaluation” field are the same as those described in FIG. 4.

The “Purchase” field stores purchase information on the purchase of recommendation products presented to the user.

The purchase information includes, for example, at least one of the following:
Information on the shipping address of the product;
Information on payment (credit card number information), or the like.

### (5-1-2) Process of Recommendation Makeup Information Presentation

The process of recommendation makeup information presentation of the variation 1 will be described.

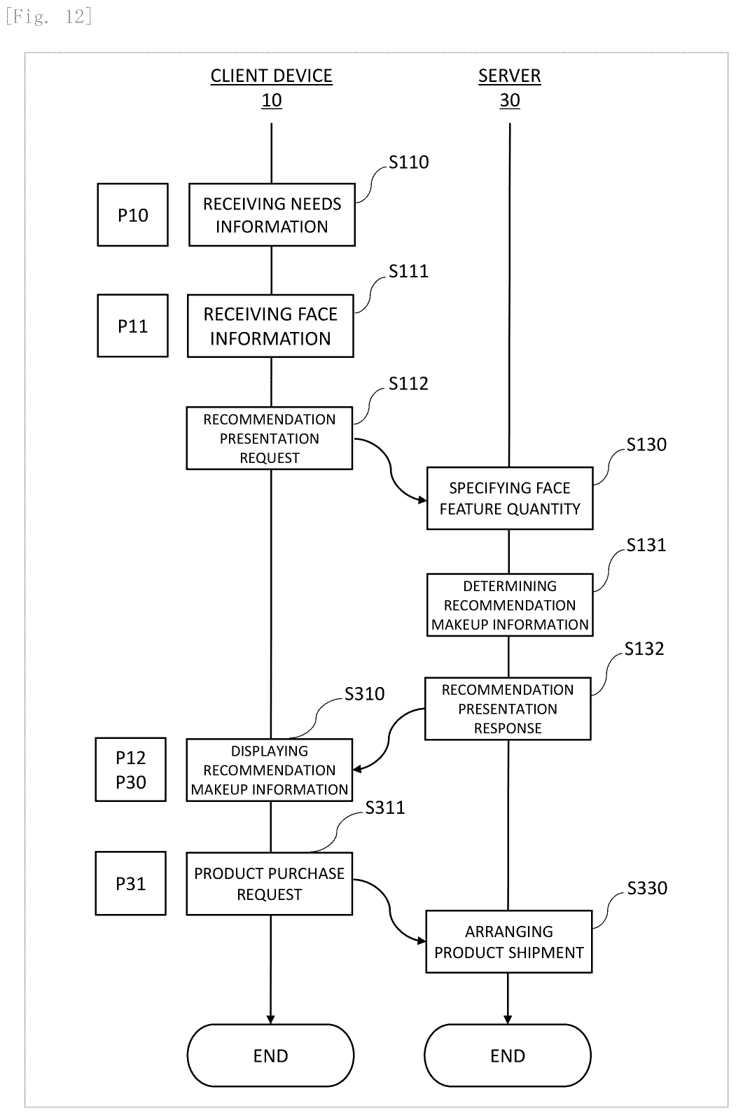

FIG. 12 is a flow chart of process of recommendation makeup information presentation of the variation 1

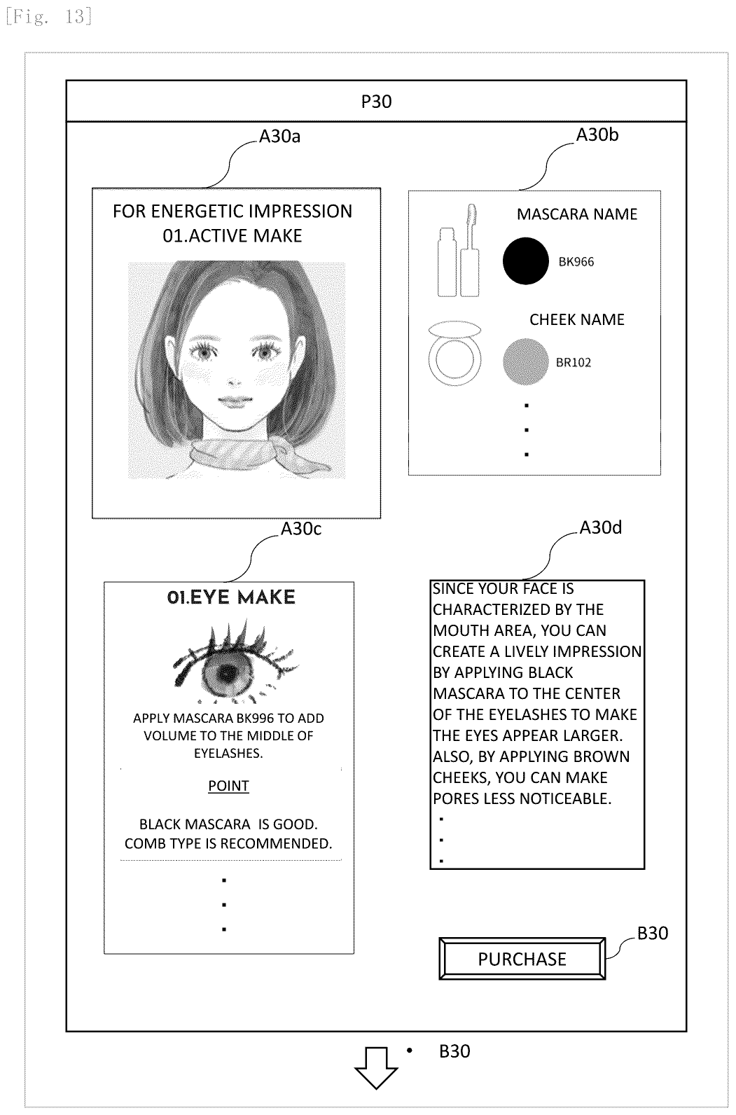

FIG. 13 is a diagram showing an example of a screen displayed in process of recommendation makeup information presentation of the variation 1.

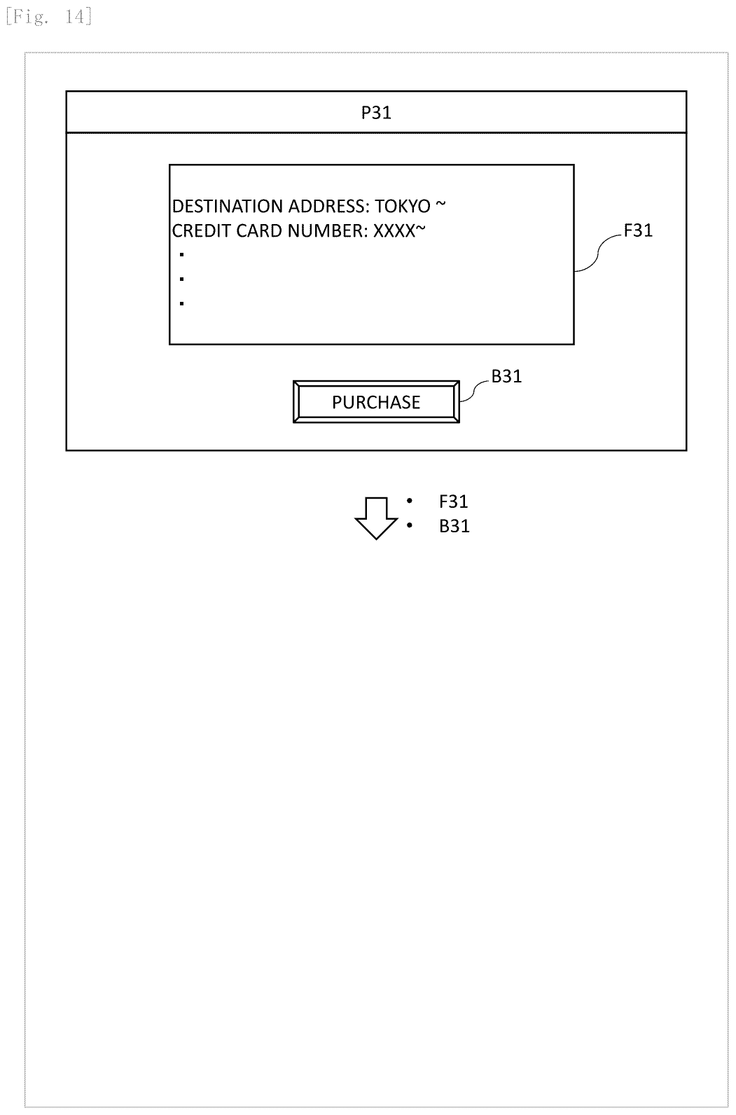

FIG. 14 is a diagram showing an example of a screen displayed in process of recommendation makeup information presentation of the variation 1.

The client apparatus 10 executes steps S110 to S112 as in FIG. 5.

After step S112, the server 30 executes steps S130 to S132 in the same manner as in FIG. 5.

After step S132, the client apparatus 10 displays recommendation makeup information (S310).

Specifically, the processor 12 displays the screen P12 (FIG. 7) on the display as in FIG. 5.

When the user operates the operation object B12, the processor 12 displays the screen P30 (FIG. 13) on the display.

The screen P30 includes display objects A30a to A30d and an operation object B30.

The display objects A30a to A30d are the same as the display objects A13a to A13d of the screen P13 (FIG. 8).

The operation object B30 is an object that receives a user instruction for transitioning to the screen P31 (FIG. 14).

After step S310, the client apparatus 10 executes a product purchase request (S311).

Specifically, when the user who wants to purchase the presented recommendation product operates the operation object B30, the processor 12 displays the screen P31 (FIG. 14) on the display.

The screen P31 includes a field object F31 and an operation object B31.

The field object F31 is an object that receives user instructions for designating product purchase information (information on product shipping address, information on payment, or the like) necessary for purchasing product.

The operation object B31 is an object that receives a user instruction for transmitting the user instruction input to the field object F31 to the server 30.

When the user designates product purchase information in the field object F31 and operates the operation object B31, the processor 12 stores the product purchase information in the memory 11.

The processor 12 transmits product purchase request data to the server 30.

The product purchase request data includes the following information:
User ID;
Recommendation log ID included in recommendation presentation response data; and
Product purchase information stored in the memory 11.

After step S311, the server 30 executes arranging product shipment (S330).

Specifically, the processor 32 stores the product purchase information included in the product purchase request data in the “purchase history” field associated with the recommendation log ID included in the product purchase request data in the recommendation log information database (FIG. 11) associated with the user ID included in the product purchase request data.

The processor 32 transmits product shipping request data to the user, for example, to an external server other than the server 30 (for example, a product shipping system).

In one example, the processor 32 refers to the user information database (FIG. 3) and transmits information for displaying a screen for evaluating the recommendation makeup information to the contact associated with the user ID included in the product purchase request data. Such information includes, for example, text including a URL (Uniform Resource Locator) in which the recommendation log ID included in the product purchase request data is embedded, or the like.

The transmission can be performed at any predetermined timing, for example, when the server 30 acquires information indicating that the product has been shipped to the user, or acquires information indicating that the product has arrived at the user.

In another example, information for displaying a screen for evaluating recommendation makeup information may be transmitted to the user together with the product. Such information includes, for example, a two-dimensional barcode assigned a URL embedded with a recommendation log ID included in the product purchase request data, or texts including a URL embedded with a recommendation log ID included in the product purchase request data, or the like.

After the product arrives, the user applies makeup according to the presented recommendation makeup information.

Currently, for example, when the user designates a user ID for logging in and accesses the above URL via the client apparatus 10, the server 30 transmits a recommendation method presentation response data including recommendation method information corresponding to the recommendation log ID.

The client apparatus 10 displays a screen (for example, screen P13 (FIG. 8)) including the recommendation method information included in the recommendation method presentation response data on the display.

The screen includes, for example, an object that receives a user instruction for transitioning to screen P20 (FIG. 10).

The user applies makeup while looking at the screen (for example, screen P13 (FIG. 8)).

### (5-1-3) Process of User Feedback

The process of user feedback of the variation 1 is, for example, the same as the process of user feedback of the present embodiment.

Note that, in the variation 1, “acquisition” is not limited to “purchase”, and may be, for example, ordering samples.

In addition, in the variation 1, only some of the recommendation makeup products may be obtained, or all of them may be obtained.

For example, if the user already has some recommendation makeup products (for example, eyeshadow), only other recommendation makeup products (for example, products other than eyeshadow) may be obtained.

According to the variation 1, the user can obtain recommendation makeup products, and evaluation information is received from users who have obtained the makeup products.

In this way, it is possible to ensure the certainty that the user has applied makeup in accordance with the recommendation makeup information when the user has obtained the recommended product.

Therefore, the reliability of this information processing system is enhanced.

### (5-2) Variation 2

Variation 2 will be described.

The variation 2 is an example of receiving evaluation information from a user who has sent a face image to which the makeup is applied (hereinafter referred to as a “makeup face image”) to the server 30.

### (5-2-1) Process of Recommendation Makeup Information Presentation

The process of recommendation makeup information presentation of the variation 2 will be described.

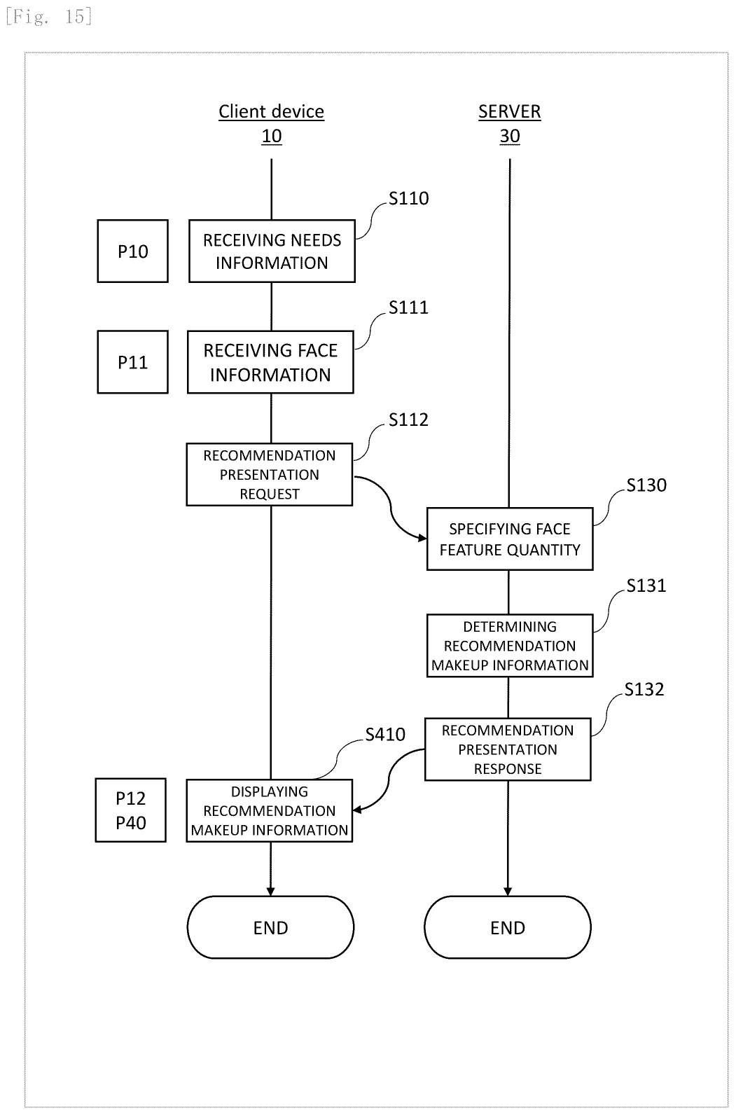

FIG. 15 is a flow chart of process of recommendation makeup information presentation of the variation 2.

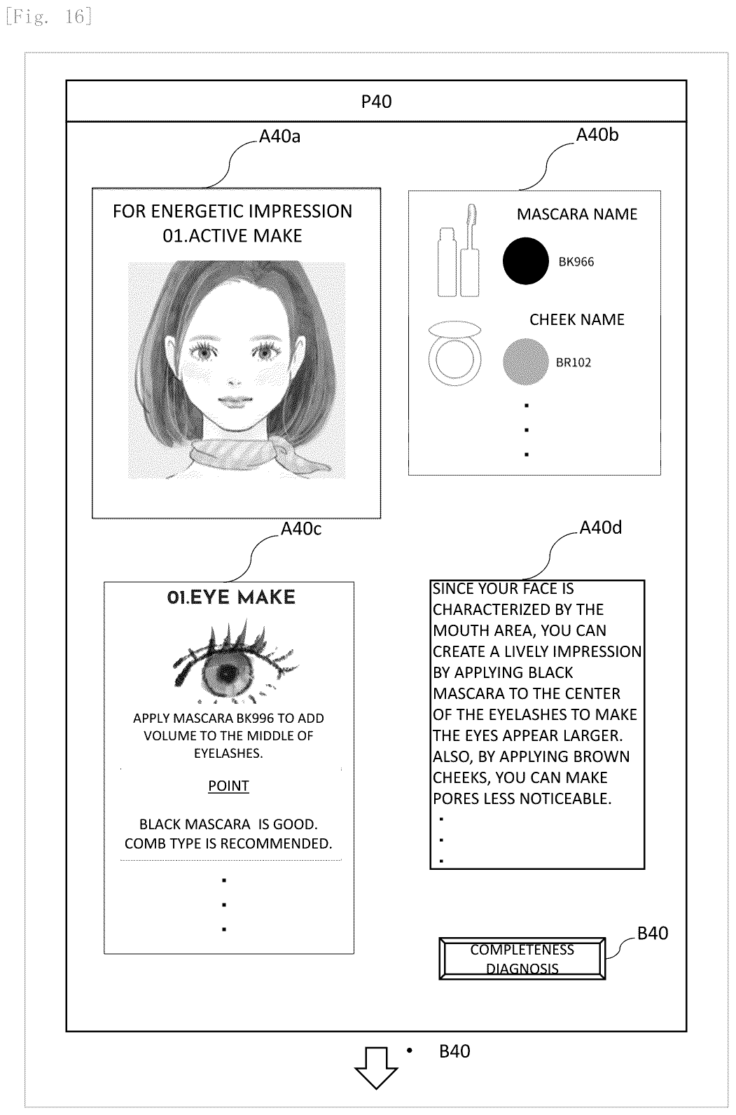

FIG. 16 is a diagram showing an example of a screen displayed in process of recommendation makeup information presentation of the variation 2.

The client apparatus 10 executes steps S110 to S112 as in FIG. 5.

After step S112, the server 30 executes steps S130 to S132 in the same manner as in FIG. 5.

After step S132, the client apparatus 10 executes displaying recommendation makeup information (S410).

Specifically, the processor 12 displays the screen P12 (FIG. 7) on the display as in FIG. 5.

When the user operates the operation object B12, the processor 12 displays the screen P40 (FIG. 16) on the display.

The screen P40 includes display objects A40a to A40d and an operation object B40.

The display objects A40a to A40d are the same as the display objects A13a to A13d of the screen P13 (FIG. 8).

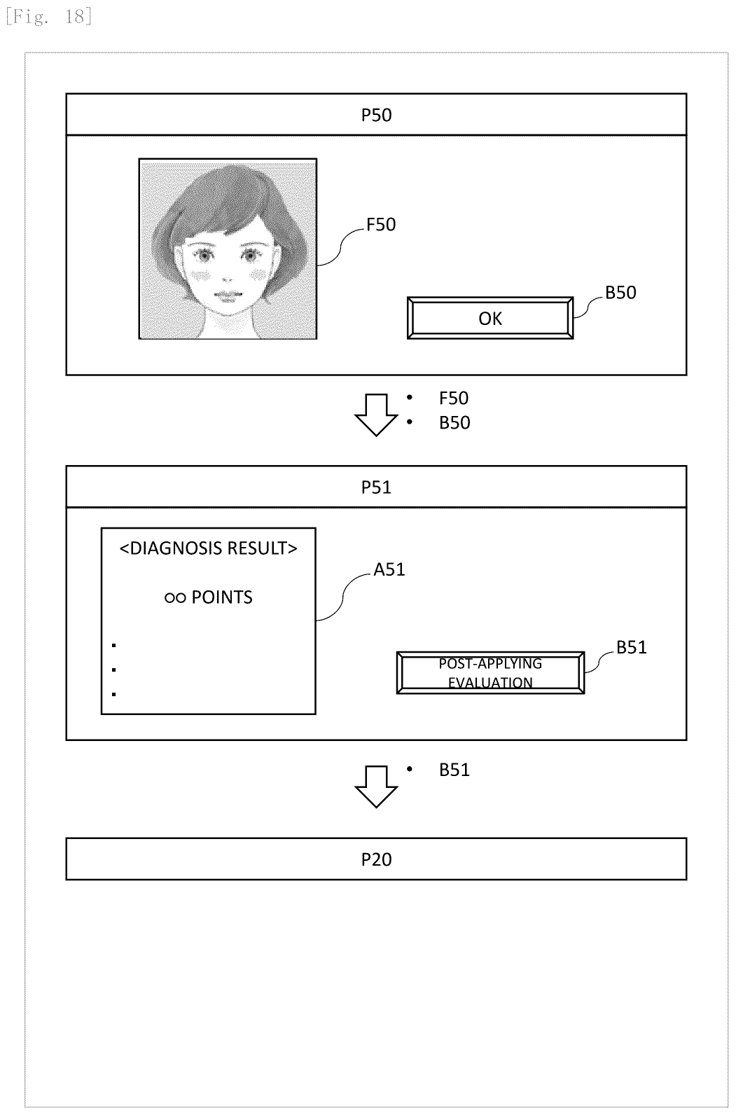

The operation object B40 is an object that receives a user instruction for transitioning to the screen P50 (FIG. 18).

After step S410, the user applies makeup according to the presented recommendation makeup information.

Currently, for example, the user applies makeup while looking at the screen P40 (FIG. 16).

### (5-2-2) Process of User Feedback

Process of user feedback of the variation 2 will be described.

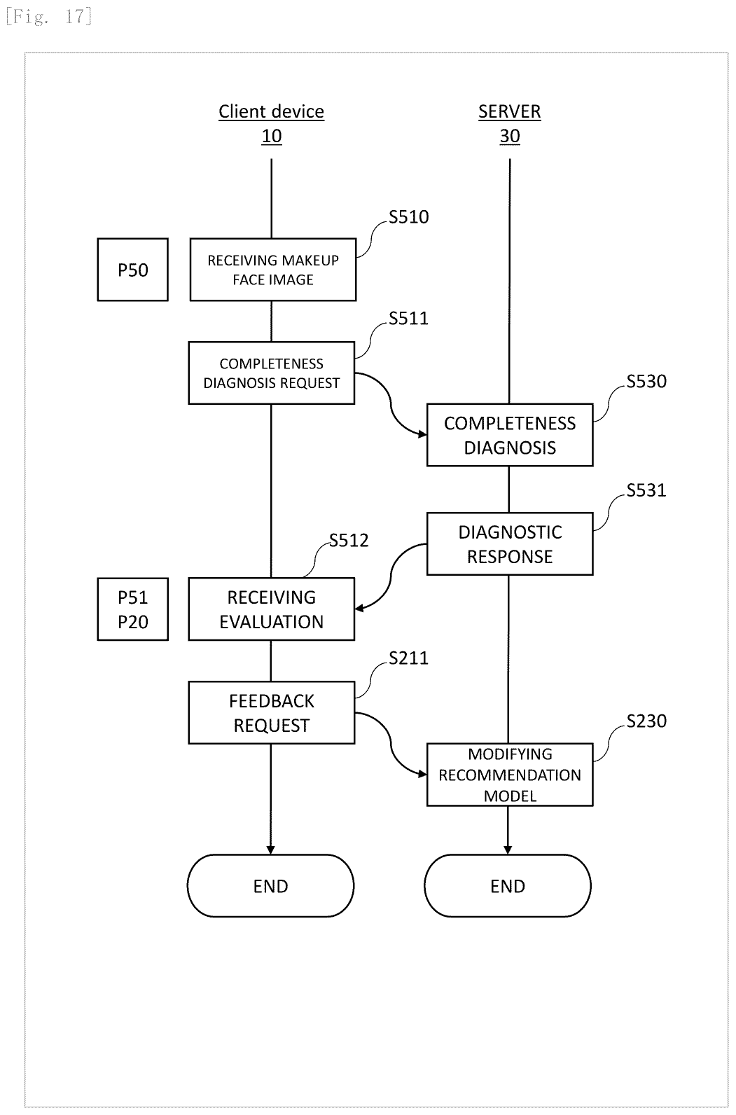

FIG. 17 is a flowchart of process of user feedback of the variation 2.

FIG. 18 is a diagram showing an example of a screen displayed in process of user feedback of the variation 2.

The process of user feedback in FIG. 17 is processing that is executed after the user applies makeup according to the presented recommendation makeup information.

As shown in FIG. 17, the client apparatus 10 executes receiving makeup face image (S510).

Specifically, when the user who has applied makeup according to the recommendation makeup information operates the operation object B40 on the screen P40 (FIG. 16), the processor 12 displays the screen P50 (FIG. 18) on the display.

The screen P50 includes a field object F50 and an operation object B50.

The field object F50 is an object that receives a user instruction for designating a user's makeup face image to which makeup has been applied based on recommendation makeup information.

The operation object B50 is an object that receives a user instruction for transmitting the user instruction input to the field object F50 to the server 30.

When the user designates the image data of his or her makeup face image (the makeup face image to which makeup is applied based on the recommendation makeup information) in the field object F50 and operates the operation object B50, the processor 12 stores the image data of the makeup face image in the memory 11.

The makeup face image may be a still image or a moving image.

Also, the number of makeup face images may be one or plural.

A makeup face image is, for example, a face image captured by the camera 15.

After step S510, the client apparatus 10 executes a completeness diagnosis request (S511).

Specifically, processor 12 transmits diagnostic request data to the server 30.

Diagnosis request data includes, for example, the following information:
User ID;
Recommendation log ID included in recommendation presentation response data; and
Image data of the makeup face image stored in the memory 11 in step S510.

After step S511, the server 30 executes a completeness diagnosis (S530).

Specifically, the processor 32 diagnoses the completeness of the makeup applied by the user based on the image data included in the diagnosis request data.

The diagnosis may further refer to at least one of recommendation makeup information associated with the recommendation log ID included in the diagnosis request data and the user's face image received in step S130.

The diagnosis is performed using, for example, a diagnostic model stored in the memory 31.

The diagnostic models include known models.

After step S530, the server 30 executes a diagnosis response (S531).

Specifically, the processor 32 transmits diagnostic response data to the client apparatus 10.

The diagnostic response data includes the following information:
Diagnosis result information on the result of diagnosis in step S530; and
Evaluation item information.

After step S531, the client apparatus 10 executes receiving evaluation (S512).

Specifically, the processor 12 displays a screen P51 (FIG. 18) on the display.

The screen P51 includes a display object A51 and an operation object B51.

The display object A51 includes diagnostic result information included in the diagnostic response data.

The operation object B51 is an object that receives a user instruction for transitioning to the screen P20 (FIG. 10).

When the user operates the field object F51, the processor 12 displays the screen P20 (FIG. 10) on the display.

When the user designates the evaluation information in the field object F20 and operates the operation object B20 as in step S210, the processor 12 stores the evaluation information in the memory 11.

After step S512, the client apparatus 10 executes step S211 as in FIG. 5.

After step S211, the server 30 executes step S230 as in FIG. 5.

According to the variation 2, evaluation information is received from the user who sent the makeup face image.

In this way, it is possible to ensure the certainty that the user has applied makeup in accordance with the recommendation makeup information when the user has sent the makeup face image.

Therefore, the reliability of this information processing system is enhanced.

### (5-3) Variation 3

Variation 3 will be described.

The variation 3 is an example in which recommendation makeup information reflecting the evaluation is re-determined and presented to the user who has evaluated.

### (5-3-1) Process of User Feedback

Process of user feedback of the variation 3 will be described.

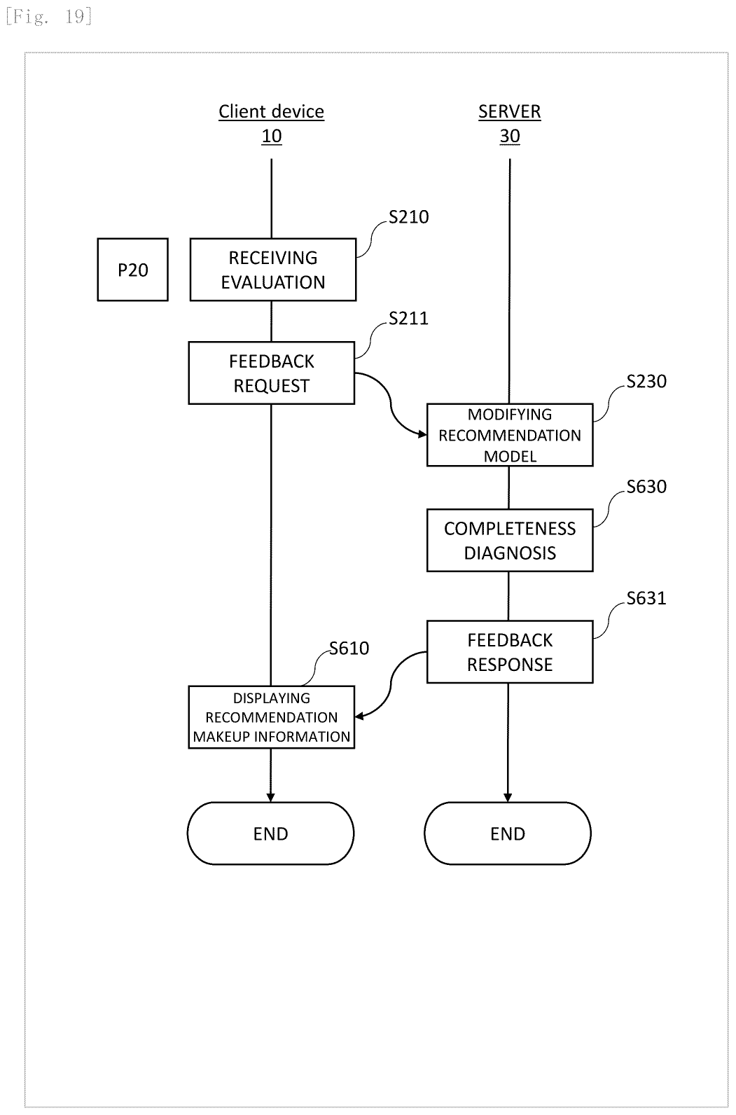

FIG. 19 is a flowchart of process of user feedback of the variation 3.

In the variation 3, as shown in FIG. 19, after step S230, the server 30 executes redetermining recommendation makeup information (S630).

Specifically, the processor 32 inputs the face feature quantity specified in step S130 and the needs information included in the recommendation presentation request data into the recommendation model modified in step S230, thereby outputting the makeup information corresponding to needs information and the face feature quantity as recommendation makeup information.

The processor 32 adds a new record to the recommendation log information database (FIG. 4) as in step S131.

After step S630, the server 30 executes a feedback response (S631).

Specifically, the processor 32 transmits feedback response data to the client apparatus 10.

The feedback response data includes the following information:
Recommendation log ID stored in the “recommendation log ID” field in step S630;
Recommendation makeup information re-determined in step S630 (the recommendation product information, the recommendation method information, the recommended reason information, and the recommendation type information).

After step S631, the client apparatus 10 executes displaying recommendation makeup information (S610).

Specifically, similarly to step S113, the processor 12 displays a screen including the recommendation makeup information re-determined in step S630 on the display.

After step S610, the user may apply makeup according to the recommendation makeup information presented in step S610.

Further, the server 30 may receive the evaluation information for the recommendation makeup information from a user who has applied makeup according to the recommendation makeup information.

Moreover, the server 30 may further modify the recommendation model based on the evaluation information.

According to the variation 3, the recommendation makeup information in consideration of the evaluation information is immediately presented to the user who has evaluated.

Therefore, the user can immediately receive a makeup proposal that will give a sufficient satisfaction when applying makeup.

This gives the user an incentive to perform the evaluation.

As a result, learning of the recommendation model can be promoted.

### (5-4) Variation 4

The variation 4 will be described.

The variation 4 is an example of presenting a reward to the user who has performed the evaluation.

### (5-4-1) Process of User Feedback

Process of user feedback of the variation 4 will be described.

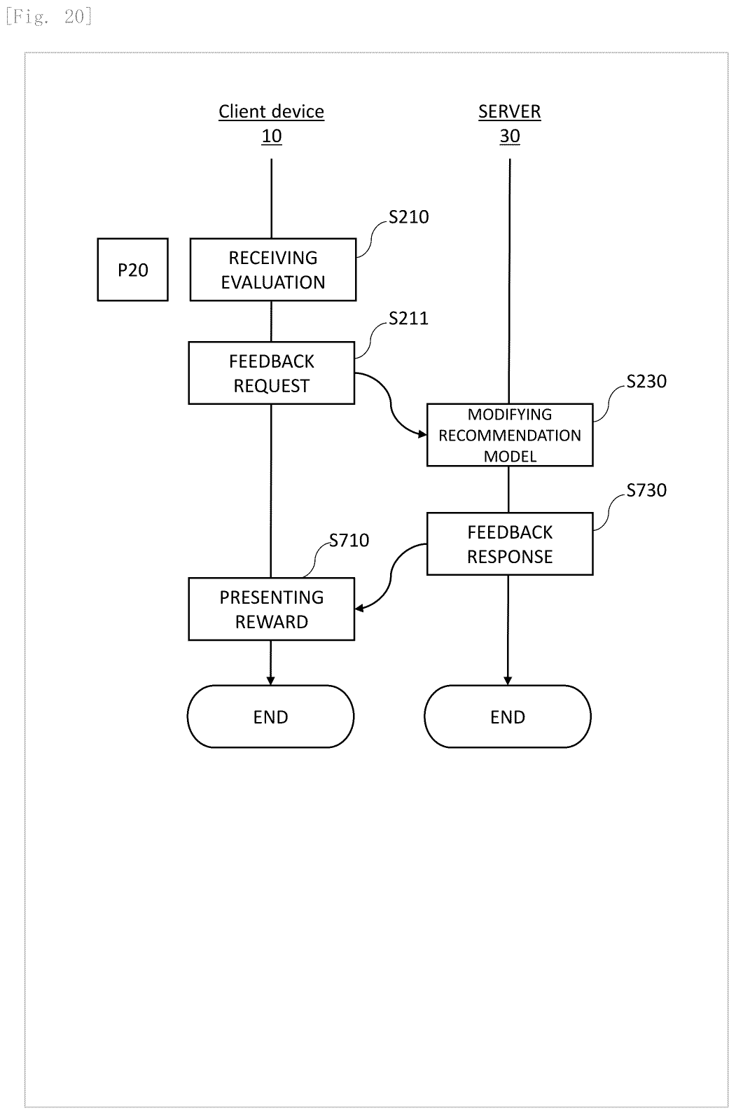

FIG. 20 is a flowchart of process of user feedback of the variation 4.

In the variation 4, as shown in FIG. 20, the server 30 executes a feedback response (S730) after step S230.

Specifically, the processor 32 transmits feedback response data to the client apparatus 10.

Feedback response data includes, for example, at least one of the following:
Information on coupons that can be used to purchase makeup products recommended to users (hereinafter referred to as “coupon information”); and
Information on counselor's advice to users (hereinafter referred to as “advice information”).

After step S730, the client apparatus 10 executes presenting reward (S710).

Specifically, the processor 12 displays at least one of coupon information and advice information (both examples of “reward”) included in the feedback response data on the display.

According to the variation 4, a reward is presented to the user who has performed the evaluation.

This gives the user an incentive to perform the evaluation.

As a result, learning of the recommendation model can be promoted.

### (5-5) Variation 5

Variation 5 will be described.

The variation 5 is an example of receiving finish information from a user who has applied makeup.

### (5-5-1) Process of User Feedback

The process of the user feedback of the variation 5 will be described.

In the variation 5, in step S210, the client apparatus 10 receives finish information and evaluation.

Specifically, the processor 12 displays a screen for receiving finish information on the display.

When the user designates the relationship with the recommendation makeup (for example, the recommendation log ID (for example, the user selects from a plurality of the presented recommendation makeups)), and designates at least one of the makeup face image (for example, the face image captured by the camera 15), a description of the applied makeup method (for example, the user inputs text), and a description of the used product (for example, the user inputs text), the processor 12 stores finish information in the memory 11.

The processor 12 executes receiving evaluations as in the present embodiment.

After step S210, the client apparatus 10 executes a feedback request (S211).

Specifically, the processor 12 transmits the feedback request data to the server 30.

Feedback request data includes, for example, the following information.
User ID;
Recommendation log ID;
Finishing information stored in the memory 11 in step S210; and
Evaluation information stored in the memory 11 in step S210.

After step S211, the server 30 executes modifying recommendation model (S230).

In the variation 5, the recommendation log information database (FIG. 4) includes a “finish information” field, and the processor 32 stores the finish information included in the feedback request data in the “finish information” field.

In the variation 5, the modification model describes the correlation among the evaluation item information, the finish information, and the modification parameters of the coefficients of the recommendation model.

The processor 32 inputs the evaluation result information and the finish information for each evaluation item included in the feedback request data to the modification model, thereby determining the modification parameters of the coefficients of the recommendation model.

The processor 32 modifies each coefficient of the recommendation model using the modification parameters.

After step S230, the server 30 executes step S231 as in the present embodiment.

Note that the finish information described above may be used in determining the recommendation makeup information (S131).

According to the variation 5, the finish information can be used to determine recommendation makeup information for the next time onward.

That is, the recommendation makeup from the next time onwards is determined in consideration of the finish information.

Therefore, it is possible to propose makeup that will give the user a sufficient satisfaction when applying makeup.

### (6) Summary of the Present Embodiment

This embodiment will be summarized.

The first aspect of the present embodiment is an information processing apparatus (for example, the server 30) comprising:
a module (for example, the processor 32 executing step S130) configured to receive face information on a user's face and needs information on the user's needs regarding makeup;
a module (for example, the processor 32 executing step S130) configured to specify a feature quantity of the user's face based on the face information;
a module (for example, the processor 32 executing step S131) configured to determine recommendation makeup information on the makeup recommended for the user based on the specified feature quantity and the needs information;
a module (for example, the processor 32 executing step S132) configured to present the determined recommendation makeup information to the user; and
a module (for example, the processor 32 executing step 230) configured to receive evaluation information on evaluation of the recommendation makeup information from the user who has applied the makeup after the recommendation makeup information is presented.

According to the first aspect, the evaluation information on the evaluation to the recommendation makeup information is received from the user who has applied makeup according to the recommendation makeup information.

Therefore, the evaluation information can be used to determine recommendation makeup information for the next time onward.

That is, the recommendation makeup for the next time onward is determined in consideration of the evaluation information based on the results of the makeup performed by the user according to the recommendation makeup information.

Therefore, it is possible to propose makeup that will give the user a sufficient satisfaction when applying makeup.

The second aspect of the present embodiment is the apparatus (for example, the server 30) that the module configured to determine determines the recommendation makeup information based on a history of the evaluation information associated with user identification information that identifies the user.

According to the second aspect, the recommendation makeup information is determined in consideration of the user's past evaluation information.

Therefore, it is possible to propose makeup that will give the user a sufficient satisfaction when applying makeup.

The third aspect of the present embodiment is the apparatus (for example, the server 30) that a memory (for example, the memory 31) configured to store a recommendation model describing correlation between feature quantity of the face, needs information, and makeup information on the makeup, wherein the module configured to determine recommendation makeup information refers to the recommendation model and determines the makeup information corresponding to a combination of the specified feature quantity and the received needs information as the recommendation makeup information; and a module (for example, the processor 32 executing step S230) configured to modify the recommendation model based on the received evaluation information.

According to the third aspect, a recommendation model is used to determine recommendation makeup information.

Also, the recommendation model is learned by reflecting the evaluation information given by the user.

Therefore, it is possible to propose makeup that will give the user a sufficient satisfaction when applying makeup.

The fourth aspect of the present embodiment is the apparatus (for example, the server 30) that the recommendation makeup information includes at least one of information on a makeup product recommended to the user, information on a makeup method recommended to the user, and information on the reasons why the makeup product and the makeup method are recommended to the user.

According to the fourth aspect, as the recommendation makeup information, at least one of information on the makeup product recommended to the user, information on the makeup method recommended to the user, and information on the reason why the makeup product and the makeup method are recommended is presented to the user.

Therefore, the user can know at least one of recommendation makeup products, recommendation makeup methods, and reasons why they are recommended.

If the user can know the makeup product or the makeup method, the user can easily apply specific makeup.

If the user can know the reasons why they are recommended, the user can apply makeup with a sense of satisfaction.

The fifth aspect of the present embodiment is the apparatus (for example, the server 30) that the needs information includes at least one of information on direction of makeup, information on usage scenes of makeup, information on makeup tools possessed by the user, and information on skin troubles of the user.

According to the fifth aspect, when at least one of the information on the direction of makeup, the information on the usage scene of makeup, the information on the makeup tools owned by the user, and the information on the skin concerns of the user is used as the needs information, the same effect as in the first mode can be obtained.

A sixth aspect of the present embodiment is the apparatus (for example, the server 30) that the needs information includes at least one of information on the user's makeup preferences, information on the user's attributes, information on the user's makeup skill level, and information on the user's facial features concerns.

According to the sixth aspect, in the case that at least one of information on the user's makeup preferences, information on the user's attributes, information on the user's makeup skill level, and information on the user's facial features concerns is used as the needs information, the same effect as the first aspect can be obtained.

The seventh aspect of the present embodiment is the apparatus (for example, the server 30) the evaluation information includes at least one of information on an evaluation of preference, an evaluation of the color tone of the recommendation makeup product, an evaluation of impression given by makeup, and an evaluation of makeup technique.

According to the seventh aspect, eat least one of information on evaluation regarding preference, information on evaluation regarding color tone of recommended makeup products, information on evaluation regarding impression given by makeup, and information on evaluation regarding makeup technique is received as the evaluation information.

Therefore, such information can be used to determine recommendation makeup information from the next time onward.

That is, the recommendation makeup from the next time onwards is determined in consideration of such information.

Therefore, it is possible to propose makeup that will give the user a sufficient satisfaction when applying makeup.

The eighth aspect of the present embodiment is the apparatus (for example, the server 30) comprising:
a module configured to receive, from the user, information that the user wants to obtain the recommendation makeup product, wherein
the module configured to receive the evaluation information receives the evaluation information from the user obtaining the makeup product.

According to the eighth aspect, the user can obtain the recommended makeup product, and the evaluation information is received from the user who obtained the makeup product.

In this way, it is possible to ensure the certainty that the user has applied makeup in accordance with the recommendation makeup information when the user has obtained the recommendation product.

Therefore, the reliability of this information processing system is enhanced.

A ninth aspect of the present embodiment is the apparatus (for example, the server 30) comprising:
a module (for example, the processor 32 executing step S530) configured to receive, from the user, a makeup face image of the user to which the makeup applied based on the recommendation makeup information, wherein
the module configured to receive the evaluation information receives the evaluation information from the user whose makeup face image is received.

According to the ninth aspect, the evaluation information is received from the user who sent the makeup face image.

In this way, it is possible to ensure the certainty that the user has applied makeup in accordance with the recommendation makeup information when the user has transmitted the makeup face image.

Therefore, the reliability of this information processing system is enhanced.

A tenth aspect of the present embodiment is the apparatus (for example, the server 30) comprising:
a module (for example, the processor 32 executing step S630) configured to refer to the modified recommendation model and redetermine makeup information corresponding to the combination of the specified feature quantity and the received needs information as the recommendation makeup information; and
a module (for example, the processor 32 executing step S631) configured to present the re-determined recommendation makeup information to the user.

According to the tenth aspect, recommendation makeup information in consideration of the evaluation information is immediately presented to the user who performed the evaluation.

Therefore, the user can immediately receive a makeup proposal that will give a sufficient satisfaction when applying makeup.

This gives the user an incentive to perform the evaluation.

As a result, learning (for example, learning of a recommendation model) in the information processing apparatus can be promoted.

The eleventh aspect of the present embodiment is the apparatus (for example, the server 30) comprising:
a module (for example, the processor 32 executing step S730) configured to present a reward to the user inputting the evaluation information.

According to the eleventh aspect, a reward is presented to the user who performed the evaluation.

This gives the user an incentive to perform the evaluation.

As a result, learning (for example, learning of a recommendation model) in the information processing apparatus can be promoted.

The twelfth aspect of the present embodiment is
an information processing method causing a computer (for example, the processor 32) executing the steps of:
receiving (for example, step S130) face information on a user's face and needs information on the user's needs regarding makeup;
specifying (for example, step S130) a feature quantity of the user's face based on the face information;
determining (for example, step S131) recommendation makeup information on the makeup recommended for the user based on the specified feature quantity and the needs information;
presenting (for example, step S132) the determined recommendation makeup information to the user; and
receiving (for example, step S230) evaluation information on evaluation of the recommendation makeup information from the user who has applied the makeup after the recommendation makeup information is presented.

The thirteenth aspect of the present embodiment is the method that
the step of determining determines the recommendation makeup information based on a history of evaluation information associated with user identification information that identifies the user.

The fourteenth aspect of the present embodiment is a program for causing a computer (for example, processor 32) to function as each modules described above.

### (7) Other Variations

Other variations will be described.

The memory 11 may be connected to the client apparatus 10 via the network NW.

The memory 31 may be connected to server 30 via network NW.

Each step of the information processing described above can be executed by either the client apparatus 10 or the server 30.

For example, if the client apparatus 10 may execute all steps of the above information processing, the client apparatus 10 functions as an information processing apparatus that operates stand-alone without transmitting requests to the server 30.

In the present embodiment and each variation, after step S113, the server 30 receives evaluation information (hereinafter referred to as “pre-evaluation Information”) may be received from the user who has not applies the makeup according to the recommendation makeup information.

For example, if the user feels that the makeup in the recommendation makeup information clearly does not match his or her preference, the user will not be motivated to apply makeup according to the presented recommendation makeup information.

Therefore, in such a case, the user evaluates the presented recommendation makeup information before applying makeup, and the server 30 considers the preliminary evaluation information to determine the recommendation makeup information again.

In one example, the server 30 modifies the recommendation model based on the pre-evaluation information.

As a result, it is possible to propose makeup that will give the user greater satisfaction when applying makeup.

In the present embodiment and each variation, the needs item information (for example, question items presented on the screen P10 (FIG. 6)) may be the same or different each time.

For example, invariant items such as information on user attributes and information on makeup preferences may be presented only for the first time.

In this case, for example, these pieces of received information may be stored in the memory 31, and from the second time onwards, these pieces of information may be obtained as needs information from the memory 31 and used to determine recommendation makeup information.

This saves the user the workload of inputting.

In the present embodiment and each variation, the needs item information may be prepared in a hierarchical manner (for example, by makeup skill level, by skin or facial features concerns, or by makeup tools possessed by the user, or the like).

In this case, for example, the client apparatus 10 first displays some needs item information (for example, makeup skill level, skin or facial features concerns, makeup tools owned by the user, or the like), and the server 30 determines the other needs item information based on the needs content information.

The server 30 may transmit the determined other needs item information to the client apparatus 10, and the client apparatus 10 may present the screen P10 based on this.

As a result, it is possible to receive needs information suitable for the user, and as a result, it is possible to propose makeup that will give the user greater satisfaction when applying makeup.

In the present embodiment and each variation, the server 30 may determine needs item information (for example, questions presented on the screen P10 (FIG. 6)) based on evaluation information on previously received recommendation makeup information. Alternatively, the server 30 may transmit the determined needs item information to the client apparatus 10, and the client apparatus 10 may present the screen P10 based on this.

As a result, it is possible to receive needs information suitable for the user, and as a result, it is possible to propose makeup that will give the user greater satisfaction when applying makeup.

In the present embodiment and each variation, the needs information may be input as an image (moving image or still image).

For example, the server 30 may receive needs information (for example, makeup tools or fashion styles owned by the user) as an image, analyze the image, and specify the needs information.

In the present embodiment and each variation, the face information on the user's face may be feature designation information designated by the user regarding the features of the user's face.

Alternatively, face information on the user's face may be both a face image and the feature designation information.

The characterizing information may be selected from presented options or may be entered as text.

By receiving features that are difficult to distinguish from an image (for example, whether the eyelid is single or double) as text information from the user, it is possible to specify the face feature quantity with higher accuracy.

In the present embodiment and each variation, the face information of the user may be transmitted only for the first time.

In this case, from the second time onwards, the server 30 uses the previously transmitted face information stored in the memory 31 or the face feature quantity information specified based on the face information.

Alternatively, the user may select in step S111 whether to newly transmit face information to the server 30 or use previously transmitted face information stored in the memory 31 from the second time onwards.

This saves the user the workload of picking up a face image.

In the present embodiment and each variation, the needs information may include information on user features.

The information on features may include, for example, information on types of facial features classified from face feature quantity, information on face features specified from face feature quantity, information on facial impressions specified from face feature quantity, or information on a personal color (for example, determination of blue-based and yellow-based) specified from the feature quantity, or the like.

For example, the server 30 may identify information on the features of the user based on the user's face information (for example, face image).

In the present embodiment and each variation, the server 30 may receive hair information on the user's hair.

The hair information includes, for example, information on at least one of hair length, hair color, hair wave condition, overall shape, or the like.

In one example, the hair information may be an image or hair designation information designated by the user.

The hair specifying information may be selected from presented options or may be entered as text.

In one example, the server 30 specifies the hair feature quantity based on the hair information.

The image may be the same image as the face image, and the server 30 may specify the hair feature quantity based on the face image.

In one example, the server 30 may determine recommendation makeup information based on the specified hair feature quantity.

This makes it possible to present the user with makeup information that matches the user's hair.

Therefore, the user's satisfaction is enhanced.

In the present embodiment and each variation, makeup may include hair makeup.

For example, the server 30 may present, as the recommendation makeup information, information on hair makeup recommended to the user in addition to facial makeup.

The information on hair makeup includes, for example, information on hairstyle (including at least one of hair length, hair color, hair wave condition, overall shape, or the like), information on hair styling method, and information on the reason why the hair styling and the hair styling method are recommended.

As a result, both face makeup and hair makeup can be presented to the user, and a comprehensive proposal can be made.

Therefore, the user's satisfaction is enhanced.

In the present embodiment and each variation, the image data of various images may be as follows:
Image data captured by a camera outside the client apparatus 10 and acquired by the client apparatus 10 via a wired or wireless connection;
Image data pre-stored in the memory 11;
Image data pre-stored in the memory 31;
Image data stored in advance in other memory (for example, flash memory).

In the present embodiment and each variation, the screen P12 (FIG. 7) presents information on the user's facial features in a visual display method, but the present invention is not limited to this.

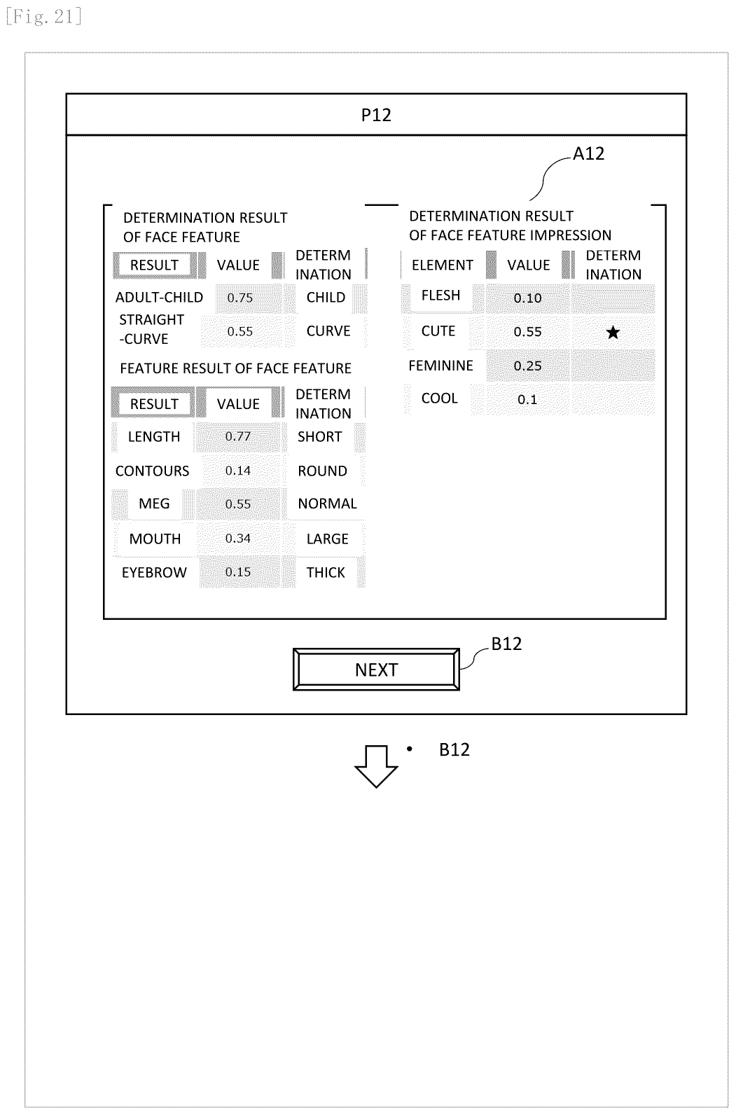

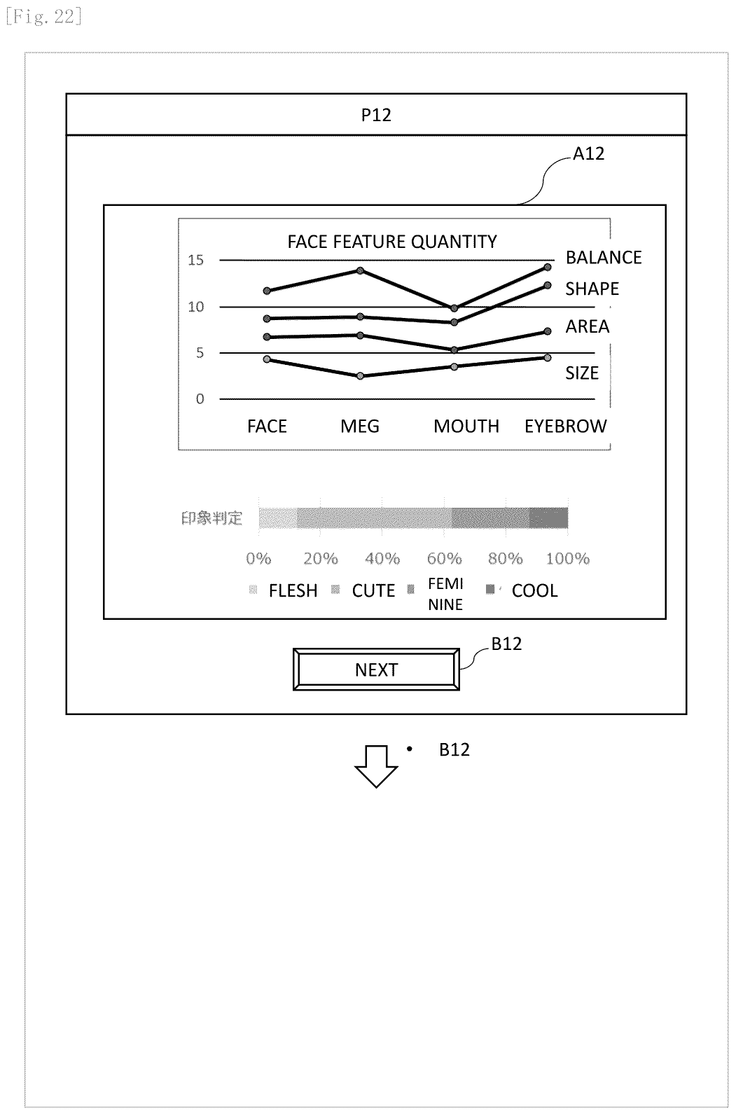

FIGS. 21 and 22 are diagrams showing variations of the screen P12 of the present embodiment.

In FIG. 21, numerical values are shown to present information on the user's facial features.

In FIG. 22, information on the user's facial features is presented in graph form.

In the present embodiment and each variation, the server 30 may determine evaluation item information (for example, questions presented on the screen P20 (FIG. 10)) based on previously received evaluation information on recommendation makeup information.

As a result, it is possible to receive evaluation information suitable for the user, and as a result, it is possible to propose makeup that will give the user greater satisfaction when applying makeup.

In step S131 of the present embodiment and each variation, recommendation makeup information on a plurality of makeups may be determined.

Also, in step S113, recommendation makeup information on a plurality of makeups may be presented.

Thereby, the user can know a plurality of makeup recommended for himself or herself.

Also, the server 30 may receive evaluation information on one or more of the recommendation makeup information from the user.

The server 30 may receive designation of recommendation makeup information to be evaluated from the user.

The same applies to redetermining the recommendation makeup information (steps S630 and S610) of the variation 3.

The server 30 may receive evaluation information on one or more of the recommendation makeup information from the user.

The server 30 may accept designation of recommendation makeup information to be evaluated from the user.

In the present embodiment and each variation, evaluation information may be received multiple times for one piece of recommendation makeup information.

At this time, the information stored in the evaluation field in the recommendation log information database (FIG. 4) may be changed from the already received information to the latest information, or the evaluation field may store both the already received information and the latest information.

This allows the next makeup to be proposed in consideration of the latest evaluation information.

Therefore, even if the user's preference changes, it is possible to propose makeup that will give the user greater satisfaction when applying makeup.

In the present embodiment and each variation, the modification model may be updated.

The updated modification model is stored in the memory 31, for example.

The recommendation model may be performed using the updated modification model.

In the present embodiment and each variation, the server 30 may present history information such as past recommendation makeup information, evaluation information, and purchase information, or the like to the user in response to a history browsing instruction received from the user.

Although the embodiments of the present invention are described in detail above, the scope of the present invention is not limited to the above embodiments.

Further, various variations and changes may be made to the above embodiments without departing from the spirit of the present invention.

In addition, the above embodiments and variations may be combined.

### REFERENCE SIGNS LIST

1: Information processing system
10: Client apparatus
11: Memory
12: Processor
13: Input and output interface
14: Communication interface
15: Camera
30: Server
31: Memory
32: Processor
33: Input and output interface
34: communication interface

1. An information processing apparatus comprising:
a module configured to receive face information on a user's face and needs information on the user's needs regarding makeup;
a module configured to specify a feature quantity of the user's face based on the face information;
a module configured to determine recommendation makeup information on the makeup recommended for the user based on the specified feature quantity and the needs information;
a module configured to present the determined recommendation makeup information to the user; and
a module configured to receive evaluation information on evaluation of the recommendation makeup information from the user who has applied the makeup after the recommendation makeup information is presented.

2. The apparatus of claim 1, wherein the module configured to determine determines the recommendation makeup information based on a history of the evaluation information associated with user identification information that identifies the user.

3. The apparatus of claim 1, further comprising:
a memory configured to store a recommendation model describing correlation between feature quantity of the face, needs information, and makeup information on the makeup, wherein
the module configured to determine recommendation makeup information refers to the recommendation model and determines the makeup information corresponding to a combination of the specified feature quantity and the received needs information as the recommendation makeup information; and
a module configured to modify the recommendation model based on the received evaluation information.

4. The apparatus of claim 1, wherein
the recommendation makeup information includes at least one of information on a makeup product recommended to the user, information on a makeup method recommended to the user, and information on why the makeup product and the makeup method is recommended to the user.

5. The apparatus of claim 1, wherein
the needs information includes at least one of information on direction of makeup, information on usage scenes of makeup, information on makeup tools possessed by the user, and information on skin troubles of the user.

6. The apparatus of claim 1, wherein
the needs information includes at least one of information on the user's makeup preferences, information on the user's attributes, information on the user's makeup skill level, and information on the user's facial features concerns.

7. The apparatus of claim 1, wherein
the evaluation information includes at least one of information on an evaluation of preference, an evaluation of the color tone of the recommendation makeup product, an evaluation of impression given by makeup, and an evaluation of makeup technique.

8. The apparatus of claim 1, further comprising
a module configured to receive, from the user, information that the user wants to obtain the recommendation makeup product, wherein
the module configured to receive the evaluation information receives the evaluation information from the user obtaining the makeup product.

9. The apparatus of claim 1, further comprising
a module configured to receive, from the user, a makeup face image of the user to which the makeup applied based on the recommendation makeup information, wherein
the module configured to receive the evaluation information receives the evaluation information from the user whose makeup face image is received.

10. The apparatus of claim 3, further comprising:
a module configured to refer to the modified recommendation model and redetermine makeup information corresponding to the combination of the specified feature quantity and the received needs information as the recommendation makeup information; and
a module configured to present the re-determined recommendation makeup information to the user.

11. The apparatus of claim 1, further comprising
a module configured to present a reward to the user inputting the evaluation information.

12. An information processing method causing a computer executing the steps of:
receiving face information on a user's face and needs information on the user's needs regarding makeup;
specifying a feature quantity of the user's face based on the face information;
determining recommendation makeup information on the makeup recommended for the user based on the specified feature quantity and the needs information;
presenting the determined recommendation makeup information to the user; and
receiving evaluation information on evaluation of the recommendation makeup information from the user who has applied the makeup after the recommendation makeup information is presented.

13. The method of claim 12, wherein
the step of determining determines the recommendation makeup information based on a history of evaluation information associated with user identification information that identifies the user.

14. (canceled)

15. The apparatus of claim 2, further comprising:
a memory configured to store a recommendation model describing correlation between feature quantity of the face, needs information, and makeup information on the makeup, wherein the module configured to determine recommendation makeup information refers to the recommendation model and determines the makeup information corresponding to a combination of the specified feature quantity and the received needs information as the recommendation makeup information; and
a module configured to modify the recommendation model based on the received evaluation information.

16. The apparatus of claim 2, wherein
the recommendation makeup information includes at least one of information on a makeup product recommended to the user, information on a makeup method recommended to the user, and information on the reasons why the makeup product and the makeup method are recommended to the user.

17. The apparatus of claim 2, wherein
the needs information includes at least one of information on direction of makeup, information on usage scenes of makeup, information on makeup tools possessed by the user, and information on skin troubles of the user.

18. The apparatus of claim 2, wherein
the needs information includes at least one of information on the user's makeup preferences, information on the user's attributes, information on the user's makeup skill level, and information on the user's facial features concerns.

19. The apparatus of claim 2, wherein
the evaluation information includes at least one of information on an evaluation of preference, an evaluation of the color tone of the recommendation makeup product, an evaluation of impression given by makeup, and an evaluation of makeup technique.

20. The apparatus of claim 2, further comprising
a module configured to receive, from the user, information that the user wants to obtain the recommendation makeup product, wherein the module configured to receive the evaluation information receives the evaluation information from the user obtaining the makeup product.

21. A tangible computer readable storage medium storing a computer program to cause a computer executing the steps of:
receiving face information on a user's face and needs information on the user's needs regarding makeup;
specifying a feature quantity of the user's face based on the face information;
determining recommendation makeup information on the makeup recommended for the user based on the specified feature quantity and the needs information;
presenting the determined recommendation makeup information to the user; and
receiving evaluation information on evaluation of the recommendation makeup information from the user who has applied the makeup after the recommendation makeup information is presented.
